(19) United States
(12) Patent Application Publication
(10) Pub. No.: US 2024/0267825 A1
(43) Pub. Date: Aug. 8, 2024

(54) REPEATER, NETWORK DEVICE, AND COMMUNICATION METHOD FOR REPEATER

(71) Applicant: FUJITSU LIMITED, Kawasaki-shi Kanagawa (JP)

(72) Inventors: Lei ZHANG, Beijing (CN); Tsuyoshi SHIMOMURA, Kawasaki-shi (JP); Qinyan JIANG, Beijing (CN); Zhe CHEN, Beijing (CN)

(73) Assignee: FUJITSU LIMITED, Kawasaki-shi Kanagawa (JP)

(21) Appl. No.: 18/587,169

(22) Filed: Feb. 26, 2024

Related U.S. Application Data
(63) Continuation of application No. PCT/CN2021/133288, filed on Nov. 25, 2021.

(30) Foreign Application Priority Data
Aug. 29, 2021 (WO) PCT/CN2021/115189

(51) Int. Cl. H04W 40/22; H04B 7/14

(52) U.S. Cl. CPC H04W 40/22; H04B 7/14

(57) ABSTRACT

A repeater, a network device and a communication method for repeater are provided in embodiments of the present application. The communication method includes: forwarding, by the repeater, a signal from a network device by using a predefined beam or a beam indicated or configured by the network device, and/or, forwarding, by the repeater, a signal to the network device by using a predefined beam or a beam indicated or configured by the network device.

### CROSS-REFERENCE TO RELATED APPLICATION

This application is a continuation of International Application No. PCT/CN2021/133288, filed on Nov. 25, 2021, which claims priority of International Patent Application PCT/CN2021/115189 filed on Aug. 29, 2021, the entire contents of each are incorporated herein by reference.

### TECHNICAL FIELD

The present application relates to communication field.

### BACKGROUND

Compared with traditional 3G (3rd generation mobile communication technology) and 4G (4th generation mobile communication technology) systems, 5G (5th generation mobile communication technology) systems may provide greater bandwidth and higher data rates, and may support more types of terminals and vertical services. For this reason, typically deployed frequency in 5G systems are significantly higher than that in 3G and 4G systems. For example, 5G systems may be deployed in the millimeter wave band.

However, the higher the carrying frequency is, the more severe the fading that the signal encounters during transmission is. Therefore, in the actual deployment of 5G systems, especially in the millimeter band, how to better enhance cell coverage has become an urgent problem to be solved.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

In order to better solve the coverage problem of cellular mobile communication systems in actual deployment, an RF Relay/Repeater is used to amplify and forward a communication signal between a terminal equipment and a network device, and this is a common deployment method. The RF repeater has relatively broad application in the actual deployment of 3G systems and 4G systems. Generally speaking, an RF repeater is a device that amplifies and forwards back-and-forth signals between the network device and the terminal equipment in the RF domain.

The traditional RF repeater does not demodulate/decode the forwarded signal during the forwarding process. The antenna direction of the traditional RF repeater is fixed. The antenna direction of the traditional RF repeater is usually manually set and adjusted during the initial installation, so that the antenna on the base station side is directed towards the incoming wave direction of the base station and the antenna on the terminal side is directed towards the place where the deployment needs to be enhanced. During the operation of the traditional RF repeater, the antenna direction does not change. Moreover, the traditional RF repeater does not have a communication function and cannot exchange information with the base station, and thus does not support the base station to perform adaptive and/or relatively dynamic configuration.

Compared to 3G and 4G systems, 5G systems deployed in higher frequency bands and millimeter wave bands employ more advanced and complex MIMO (multiple input multiple output) technology. In the 5G system, the directed antenna becomes a basic component of the base station and the terminal equipment, and it is a basic signal transmission method in the 5G system to transmit and receive signals based on beamforming technology.

In particular, the characteristics of high frequency and small wavelength of the millimeter wave band are more conducive to providing antenna panels containing more arrays in the base station and the terminal equipment. The increase in the number of the antenna arrays allows for more accurate beamforming, that is, it is easier to form a narrow beam. Focusing energy on a narrow beam helps to enhance the signal while reducing interference with other devices. On the other hand, due to the precise pointing of the narrow beam, the requirements for channel measurement and beam management are very high, as a result, the 5G systems support complex but accurate channel measurement, antenna calibration, and beam management solutions, through which the base station may effectively and accurately control the receiving and transmitting beams of the terminal equipment to achieve better communication effects.

The inventor has found that for the coverage problem encountered in the deployment of 5G systems, use of the RF repeater for coverage enhancement is one of the feasible solutions. However, the antenna of the traditional RF repeater cannot dynamically adjust the direction and the beam is wide. Such RF repeater configured in the 5G system may help to enhance signal strength, but it also causes significant interference to other base stations or terminal equipments around due to the wider transmitting beam, and then reduce the throughput of the entire network because of the increase in new interference.

To address at least one of the above problems, provided in the embodiments of the present application are a repeater, a network device and a communication method of a repeater. By communicating with the network device, the repeater may receive indication or configuration for forwarding (such as beam indication or configuration, forwarding bandwidth, etc.) made by the network device according to real-time situation of the network, and forward the signal according to the indication or configuration. By using the repeater in the embodiment of the present application, the signal coverage may be strengthened better and the interference to other surrounding devices may be reduced, thus improving the transmission efficiency of the entire network.

According to an aspect of an embodiment of the present application, there is provided with a communication method of a repeater, including:
forwarding, by the repeater, a signal from a network device by using a predefined beam or a beam indicated or configured by the network device, and/or, forwarding, by the repeater, a signal to the network device by using a predefined beam or a beam indicated or configured by the network device.

According to another aspect of the embodiment of the present application, there is provided with a repeater, including:
a forwarding module which forwards a signal from a network device by using a predefined beam or a beam indicated or configured by the network device, and/or, forwards a signal to the network device by using a predefined beam or a beam indicated or configured by the network device.

According to another aspect of the embodiment of the present application, there is provided with a communication method of a network device, including:
transmitting to a repeater configuration information for indicating or configuring one or more beams of the repeater by the network device; and
transmitting a signal to be forwarded via the repeater, and/or receiving a signal forwarded via the repeater, by the network device.

According to another aspect of the embodiment of the present application, there is provided with a network device, including:
a configuration module which transmits to a repeater configuration information for indicating or configuring one or more beams of a repeater; and
a communication module which transmits a signal to be forwarded via the repeater, and/or receiving a signal forwarded via the repeater.

According to another aspect of the embodiment of the present application, there is provided with a communication method of a third device, including:
forwarding, by the third device, a signal to be forwarded by a repeater to a network device, and/or receiving a signal from the network device forwarded by the repeater, by using a predefined beam or a beam indicated or configured by the network device.

According to another aspect of the embodiment of the present application, there is provided with a third device, including:
a communication module which forwards a signal to be forwarded by a repeater to a network device, and/or receives a signal from the network device forwarded by the repeater, by using a predefined beam or a beam indicated or configured by the network device.

According to another aspect of the embodiment of the present application, there is provided with a communication system including a network device, wherein the communication system further includes:
a repeater which forwards a signal from the network device by using a predefined beam or a beam indicated or configured by the network device, and/or, forwards a signal to the network device by using a predefined beam or a beam indicated or configured by the network device.

One of the beneficial effects of the embodiment of the present application is that: the repeater forwards a signal by a predefined beam or a beam indicated or configured by the network device, thereby achieving better signal coverage and reducing interference to other surrounding devices, thereby improving the transmission efficiency of the entire network.

With reference to the specification and drawings below, a specific embodiment of the present application is disclosed in detail, which specifies the manner in which the principle of the present application can be adopted. It should be understood that, the scope of the embodiment of the present application is not limited. Within the scope of the spirit and clause of the appended claims, the embodiment of the present application includes many variations, modifications and equivalents.

The features described and/or shown for one embodiment can be used in one or more other embodiments in the same or similar manner, can be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

The included drawings are used for providing further understanding on the embodiment of the present application, constitute a portion of the Description, are used for illustrating the embodiment of the present application and explain the principle of the present application together with the literary description. Obviously, the drawings described below are merely some examples of the present application, persons ordinarily skilled in the art may also obtain other drawings according to these drawings without making creative efforts. In the drawings:

FIG. 1 is a schematic diagram of an application scenario of an embodiment of the present application;

FIG. 2 is a schematic diagram of a communication method of a repeater of an embodiment of the present application;

FIG. 3 is an example diagram of a repeater forwarding a downlink signal in an embodiment of the present application;

FIG. 4 is an example diagram of a repeater forwarding an uplink signal in an embodiment of the present application;

FIG. 5 is an example diagram of a repeater receiving a downlink signal in an embodiment of the present application;

FIG. 6 is an example diagram of a repeater transmitting an uplink signal in an embodiment of the present application;

FIG. 7 is an example diagram of a repeater transmitting a downlink signal in an embodiment of the present application;

FIG. 8 is an example diagram of a repeater receiving an uplink signal in an embodiment of the present application;

FIG. 9 is an example diagram of multiplexing forwarding signal resources and communication signal resources in an embodiment of the present application;

FIG. 10 is another example diagram of multiplexing forwarding signal resources and communication signal resources in an embodiment of the present application;

FIG. 11 is another example diagram of multiplexing forwarding signal resources and communication signal resources in an embodiment of the present application;

FIG. 12 is an example diagram of a repeater in an embodiment of the present application;

FIG. 13 is another example diagram of a repeater in an embodiment of the present application;

FIG. 14 is another example diagram of a repeater in an embodiment of the present application;

FIG. 15 is another example diagram of a repeater in an embodiment of the present application;

FIG. 16 is another example diagram of a repeater in an embodiment of the present application;

FIG. 17 is another example diagram of a repeater in an embodiment of the present application;

FIG. 18 is another example diagram of a repeater in an embodiment of the present application;

FIG. 19 is another example diagram of a repeater in an embodiment of the present application;

FIG. 20 is another example diagram of a repeater in an embodiment of the present application;

FIG. 21 is another example diagram of a repeater in an embodiment of the present application;

FIG. 22 is another example diagram of a repeater in an embodiment of the present application;

FIG. 23 is another example diagram of a repeater in an embodiment of the present application;

FIG. 24 is another example diagram of a repeater in an embodiment of the present application;

FIG. 25 is another example diagram of a repeater in an embodiment of the present application;

FIG. 26 is another example diagram of a repeater in an embodiment of the present application;

FIG. 27 is another example diagram of a repeater in an embodiment of the present application;

FIG. 28 is another example diagram of a repeater in an embodiment of the present application;

FIG. 29 is another example diagram of a repeater in an embodiment of the present application;

FIG. 30 is another example diagram of a repeater in an embodiment of the present application;

FIG. 31 is another example diagram of a repeater in an embodiment of the present application;

FIG. 32 is another example diagram of a repeater in an embodiment of the present application;

FIG. 33 is another example diagram of a repeater in an embodiment of the present application;

FIG. 34 is another example diagram of a repeater in an embodiment of the present application;

FIG. 35 is a schematic diagram of a repeater in an embodiment of the present application;

FIG. 36 is a schematic diagram of a communication method of a network device in an embodiment of the present application;

FIG. 37 is a schematic diagram of a network device in an embodiment of the present application; and

FIG. 38 is a schematic diagram of an electronic device in an embodiment of the present application.

### DETAILED DESCRIPTION

With reference to the drawings, the foregoing and other features of the present application will become apparent through the following description. The Description and drawings specifically disclose the particular embodiment of the present application, showing part of the embodiment in which the principle of the present application may be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present application, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system can be carried out according to the communication protocol of any stage, for example, including but not being limited to 1G (generation), 2G, 2.5G, 2.75G, 3G, 4G, 4.5G and future 5G, New Radio (NR), etc., and/or other communication protocols currently known or to be developed in the future.

In the embodiment of the present application, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” can refer to a base station and/or its coverage area, depending on the context in which the term is used.

In the embodiments of the present application, the term “user equipment” (UE) refers, for example, to a device that is connected to the communication network through the network device and receives network services, and may also be referred to as “Terminal Equipment” (TE). The terminal equipment can be fixed or movable, and can also be called a mobile station (MS), a terminal, a user, a subscriber station (SS), an access terminal (AT), a station, etc.

The terminal equipment may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

During discussions of the 3GPP (3rd Generation Partnership Program) Release 18 (Version 18), a device concept called Smart Repeater is proposed. In this device concept, the smart repeater is capable of communicating with the network device (gNB). The network device can configure the smart repeater to a certain extent, and optimize the forwarding performance of the Smart Repeater and reduce the interference to other surrounding devices.

FIG. 1 is a schematic diagram of an application scenario of an embodiment of the present application. As shown in FIG. 1, a 5G base station (gNB) 101, a repeater 102, and a terminal equipment (UE) 103 are taken as examples for the sake of illustration, and the present application is not limited to this. As shown in FIG. 1, the gNB 101 may communicate with the repeater 102 via a narrow beam; in addition, the repeater 102 may forward signals between the gNB 101 and the UE 103 over the narrow beam.

In the embodiments of the present application, existing services or services that may be implemented in the future may be transmitted between the network device and the terminal equipment. For example, these services may include, but are not limited to, enhanced mobile broadband (eMBB), large-scale machine-type communications (mMTC), highly reliable low-latency communications (URLLC), and vehicle-to-vehicle (V2X) communications, and etc.

FIG. 1 illustrates an example that the repeater may forward signals between the network device and the terminal equipment, but the present application is not limited to this. For example, the repeater may act as a second device, forward signals between the first device and the third device, and may communicate directly with the first device and/or the third device; the first device to the third device may be any device in the aforementioned network. In the embodiments below, illustration is given by taking the first device as the network device and the third device as the terminal equipment.

The various embodiments of the present application are illustrated below with reference to the accompanying drawings. These embodiments are exemplary only and are not limitations to the present application.

### Embodiments of First Aspect

An embodiment of the present application provides a communication method of a repeater, illustrated from one side of the repeater.

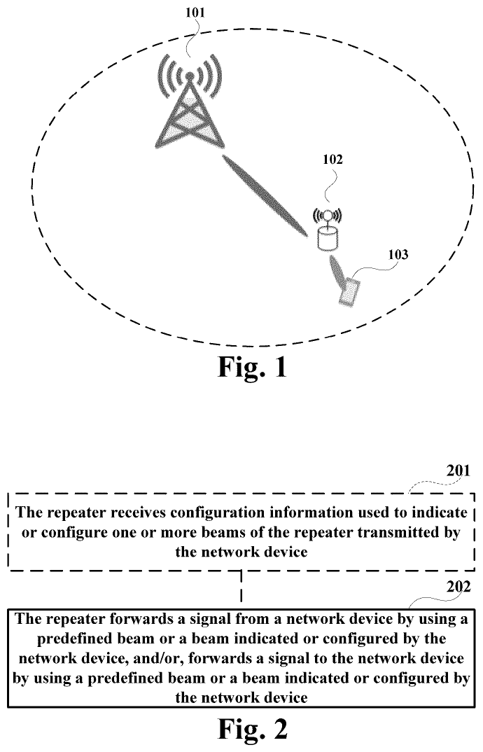

FIG. 2 is a schematic diagram of a communication method of a repeater of the embodiment of the present application, as shown in FIG. 2, the method including:
202, the repeater forwards a signal from a network device by using a predefined beam or a beam indicated or configured by the network device, and/or, forwards a signal to the network device by using a predefined beam or a beam indicated or configured by the network device.

In some embodiments, alternatively, as shown in FIG. 2, the method may further include:
201, the repeater receives configuration information transmitted by the network device, the configuration being used to indicate or configure one or more beams of the repeater.

It is worth noting that FIG. 2 above only schematically illustrates an embodiment of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 2 above.

In the embodiments of the present application, beam may also be expressed as lobe, a reference signal (RS), transmission configuration indication (TCI), a spatial domain filter, etc. Or, the beam may also be expressed as a beam index, a lobe index, a reference signal index, a transmission configuration indication index, a spatial domain filter index, etc. The reference signal above is, for example, a channel state information reference signal (CSI-RS), a sounding reference signal (SRS), an RS for use by the repeater, the RS sent by the repeater, etc. The above TCI may also be expressed as the TCI state.

In the embodiments of the present application, the repeater may also be expressed as a forwarder, an RF repeater, a relay, or an RF relay; or may also be expressed as a repeater node, a forwarder node, a relay node; or may also be expressed as a smart repeater, a smart forwarder, a smart relay, a smart repeater node, a smart forwarder node, a smart relay node, and etc., but the present application is not limited to this.

In the embodiments of the present application, the network device may be a device in a serving cell of the terminal equipment, or may also be a device in the cell where the repeater resides, or may further be a device in the serving cell of the repeater, or may also be a parent node of the repeater. The name of the repeater is not limited in the present application, and any device that may achieve the above functions shall be included in the scope of the repeater in the present application.

In the embodiments of the present application, a predefined beam or a beam indicated or configured for the repeater by the network device may be a receiving beam of the repeater, such as a receiving beam that receives a signal from the network device, or a receiving beam that receives a signal from the terminal equipment; a predefined beam or a beam indicated or configured for the repeater by the network device may be a transmitting beam of the repeater, such as a transmitting beam that transmits a signal to the network device, or a transmitting beam that transmits a signal to the terminal equipment.

The network device may indicate or configure the beam of the repeater, for example dynamically or semi-statically; the beam of the repeater may also be predefined. Therefore, compared with the current scheme that the antenna of the repeater cannot dynamically adjust the direction, the repeater of the embodiments of the present application forwards a signal by a predefined beam or a beam indicated or configured by the network device, thereby achieving better signal coverage and reducing interference to other surrounding devices, thereby improving the transmission efficiency of the entire network.

In 201 of FIG. 2, configuration information may be transmitted by the network device to the repeater, e.g. MAC (Media Access Control) layer signaling, or RRC (Radio Resource Control) signaling, but the present application is not limited to this. After receiving the configuration information, the repeater may process it accordingly, such as signal measurement and reporting, beam selection and so on. The information exchanged between the network device and the repeater is not limited to configuration information, but may also include various other control information and/or data information.

For convenience, a signal communicated between the network device and the repeater or between the third device (such as a terminal equipment) and the repeater is called a communication signal (such as the 5th signal and the 6th signal, the 7th signal and the 8th signal hereinafter). The downlink communication signal is, for example, the fifth signal, which is used for the network device to configure, schedule, and indicate the repeater, and etc., and the repeater needs to decode and/or demodulate the downlink communication signal; or the downlink communication signal is, for example, the seventh signal, which is used for the third device to perform channel measurement or estimation (of, e.g., a reference signal) and which is generated by the repeater, or which is used for the repeater to transmit information or data or the like to the third device and which is encoded and/or modulated by the repeater.

The uplink communication signal is, for example, the sixth signal, which is used for the repeater to report and provide feedback to the network device, etc., and the repeater needs to encode and/or modulate the uplink communication signal; or the uplink communication signal is, for example, the eighth signal, which is used for the repeater to perform channel measurement or estimation (of, e.g., a reference signal), and the repeater needs to receive the uplink communication signal, etc., or which is used for the third device to transmit information or data or the like to the repeater, and the repeater needs to decode and/or demodulate the uplink communication signal.

In addition, a signal between the network device and the third device that is forwarded by the repeater is referred to as a forwarding signal (such as the first signal, the second signal, the third signal, and the fourth signal hereinafter). The repeater may perform signal processing, such as filtering and amplifying, of the forwarding signal, but does not decode and/or demodulate the forwarding signal.

In some embodiments, the repeater receives the first signal from the network device by using a predefined first beam or a first beam indicated or configured by the network device; the repeater performs signal processing on the first signal to generate a second signal; and the repeater transmits the second signal to a third device by using a predefined second beam or a second beam indicated or configured by the network device.

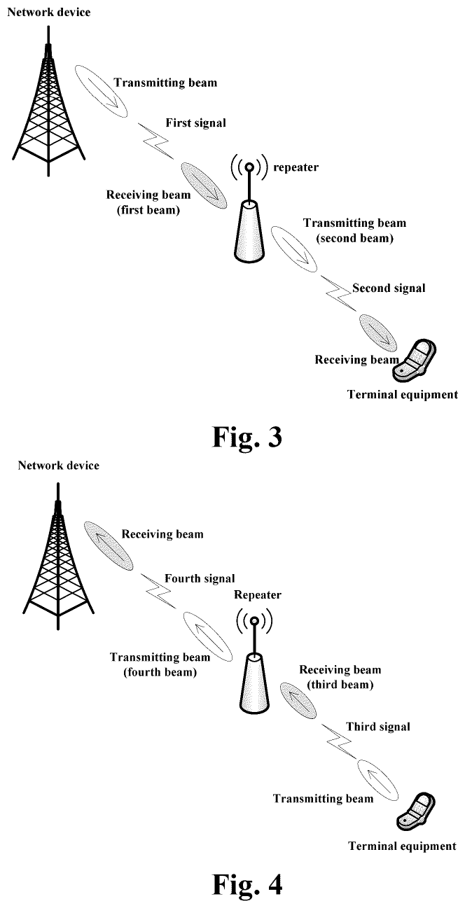

FIG. 3 is an example diagram of a repeater forwarding a downlink signal in an embodiment of the present application. As shown in FIG. 3, the network device may use a transmitting beam to transmit the first signal to the repeater, and the first signal is used, for example, for scheduling the terminal equipment. The repeater uses the first beam (for example, a receiving beam indicated or configured by the network device, or a predefined receiving beam) to receive the first signal and carries out signal processing (such as amplification etc.) to the first signal and then generates a second signal. The repeater may use a second beam (for example, a transmitting beam indicated or configured by the network device, or a predefined transmitting beam) to transmit the second signal to the terminal equipment. The terminal equipment uses the receiving beam (for example, also indicated or configured by the network device, or for example predefined) to receive the second signal.

In some embodiments, the repeater receives a third signal from the third device by using a predefined third beam or a third beam indicated or configured by the network device; the repeater performs signal processing on the third signal to generate a fourth signal; and the repeater transmits the fourth signal to the network device by using a predefined fourth beam or a fourth beam indicated or configured by the network device.

FIG. 4 is an example diagram of a repeater forwarding an uplink signal in an embodiment of the present application. As shown in FIG. 4, the terminal equipment uses a transmitting beam (e.g. indicated or configured by the network device, or e.g. predefined) to transmit the third signal, and the third signal is, for example, reported by the terminal equipment to the network device. The repeater uses the third beam (for example, a receiving beam indicated or configured by the network device, or a predefined receiving beam) to receive the third signal and carries out signal processing (such as amplification etc.) to the third signal and then generates a fourth signal. The repeater may use a fourth beam (for example, a transmitting beam indicated or configured by the network device, or a predefined transmitting beam) to transmit the fourth signal to the terminal equipment. The network device may use the receiving beam to receive the fourth signal transmitted by the repeater.

Exemplary illustration has been made hereinabove as to the signal (including an uplink forwarding signal and a downlink forwarding signal) between the network device and the third device (such as the terminal equipment) that is forwarded by the repeater, and the communication signal (including an uplink communication signal and a downlink communication signal) between the repeater and the network device is illustrated hereinafter.

In some embodiments, the repeater receives a fifth signal from the network device by using a predefined fifth beam or a fifth beam indicated or configured by the network device; and the repeater demodulates and/or decodes the fifth signal.

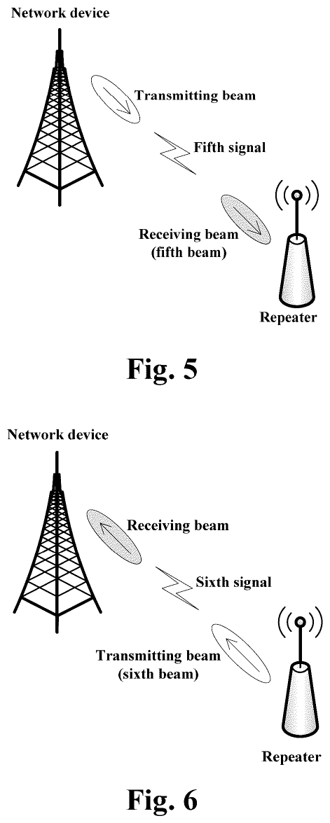

FIG. 5 is an example diagram of a repeater receiving a downlink signal in an embodiment of the present application. As shown in FIG. 5, the network device may use a transmitting beam to transmit the fifth signal to the repeater, and the fifth signal is used, for example, for scheduling or configuring the repeater. The repeater uses the fifth beam (for example, a receiving beam indicated or configured by the network device, or a predefined receiving beam) to receive the fifth signal and demodulates/decodes the fifth signal, so as to perform corresponding processing according to the content carried by the fifth signal, such as acquiring information carried by the fifth signal and/or performing channel estimation or channel measurement or the like by using a reference signal carried by the fifth signal.

In some embodiments, the repeater generates a sixth signal; and the repeater transmits the sixth signal to the network device by using a predefined sixth beam or a sixth beam indicated or configured by the network device.

FIG. 6 is an example diagram of a repeater transmitting an uplink signal in an embodiment in of the present application. As shown in FIG. 6, the repeater generates (e.g. including modulation/coding) a sixth signal, which is for example used by the repeater to report measurement results or feedback information to the network device. The repeater may use a sixth beam (for example, a transmitting beam indicated or configured by the network device, or a predefined transmitting beam) to transmit the sixth signal to the network device. The network device may use the receiving beam to receive the sixth signal transmitted by the repeater, so as to perform corresponding processing according to the content carried by the sixth signal.

The communication signal (including an uplink communication signal and a downlink communication signal) between the repeater and the third device (such as the terminal equipment) is further illustrated hereinafter.

In some embodiments, the repeater generates a seventh signal; and the repeater transmits the seventh signal to the third device by using a predefined seventh beam or a seventh beam indicated or configured by the network device.

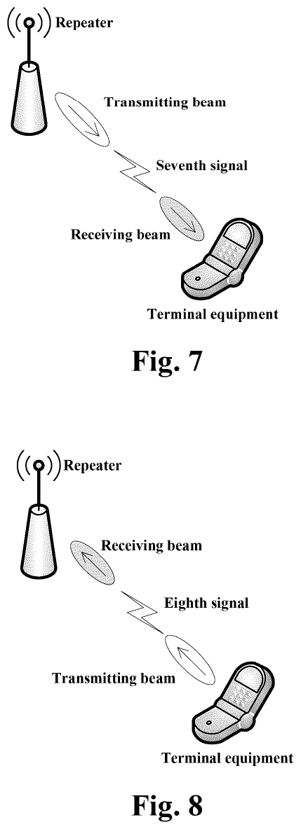

FIG. 7 is an example diagram of a repeater transmitting a downlink signal in an embodiment of the present application. As shown in FIG. 7, the repeater generates (for example including modulates/encodes, or sequence generation and modulation of reference signals) a seventh signal, which is used, for example, by the terminal equipment for channel measurement or estimation (of e.g., a reference signal), or for the repeater to transmit information or data or the like to the terminal equipment, etc. The repeater may use a seventh beam (for example, a transmitting beam indicated or configured by the network device, or a predefined transmitting beam) to transmit the seventh signal to the terminal equipment. The terminal equipment may use the receiving beam to receive the seventh signal transmitted by the repeater, so as to perform corresponding processing according to the content carried by the seventh signal.

In some embodiments, the repeater receives an eighth signal from the third device by using a predefined eighth beam or an eighth beam indicated or configured by the network device; and the repeater demodulates and/or decodes the eighth signal.

FIG. 8 is an example diagram of a repeater receiving an uplink signal in an embodiment of the present application. As shown in FIG. 8, the terminal equipment may use a transmitting beam to transmit the eighth signal to the repeater, and the eighth signal, for example, is used for the repeater to perform channel measurement or estimation (of, e.g., a reference signal), or for the terminal equipment to transmit information or data or the like to the repeater, etc. The repeater uses the eighth beam (for example, a receiving beam indicated or configured by the network device, or a predefined receiving beam) to receive the eighth signal and demodulates/decodes the eighth signal, so as to perform corresponding processing according to the content carried by the eighth signal.

FIG. 3 to FIG. 8 provide exemplary illustrations of the forwarding signal and the communication signal respectively, but the present application is not limited to this. The forwarding signal and the communication signal may be transmitted separately or by being combined in a single signal. For example, one or any combination of time division (TD), frequency division (FD), code division (CD), space division, etc. may be used, and the present application is not limited to this.

In some embodiments, the fifth signal transmitted by the network device to the repeater and the first signal transmitted by the network device to the third device via the repeater are contained in the same signal from the network device.

For example, time-domain resources of the fifth signal and time-domain resources of the first signal are at least partially identical, and frequency-domain resources of the fifth signal are different from frequency-domain resources of the first signal and/or code-domain resources of the fifth signal are different from code-domain resources of the first signal.

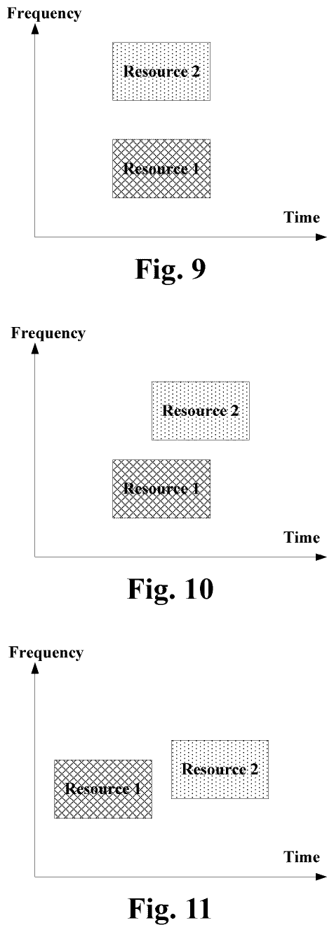

FIG. 9 is an example diagram of multiplexing forwarding signal resources and communication signal resources in an embodiment of the present application. As shown in FIG. 9, for example, the resource that transmits the fifth signal is resource 1, and the resource that transmits the first signal is resource 2. The resource 1 and the resource 2 are the same in the time domain (for example, on the same symbol in the same time slot), but different in the frequency domain.

FIG. 10 is another example diagram of multiplexing forwarding signal resources and communication signal resources in an embodiment of the present application. As shown in FIG. 10, for example, the resource that transmits the fifth signal is resource 1, and the resource that transmits the first signal is resource 2. The resource 1 and the resource 2 are partially the same in the time domain (e.g. partial symbol overlap), but different in the frequency domain.

For another example, frequency-domain resources of the fifth signal and frequency-domain resources of the first signal are at least partially identical, and time-domain resources of the fifth signal are different from time-domain resources of the first signal and/or code-domain resources of the fifth signal are different from code-domain resources of the first signal.

FIG. 11 is another example diagram of multiplexing forwarding signal resources and communication signal resources in an embodiment of the present application. As shown in FIG. 11, for example, the resource that transmits the fifth signal is resource 1, and the resource that transmits the first signal is resource 2. The resource 1 and the resource 2 are partially the same in the frequency domain (e.g. partial sub-carrier overlap), but different in the time domain.

In some embodiments, the fifth signal and the first signal in a unit of time are orthogonal. After receiving the same signal above, the repeater and/or terminal equipment may use the orthogonality between the fifth signal and the first signal to obtain the fifth signal and/or the first signal from the same signal.

For example, the time-frequency resources of the fifth signal and the time-frequency resources of the first signal are in a time unit, and the time unit may be one of the following: a symbol, a slot, a sub-frame, a mini-slot, a smallest scheduling unit not based on slot scheduling;
the time-frequency resources of the fifth signal are orthogonal to the time-frequency resources of the first signal, and/or, code-domain resources of the fifth signal are orthogonal to code-domain resources of the first signal, and/or, the fifth signal and the first signal are orthogonal in a spatial domain.

Thus, the downlink communication signal transmitted by the network device to the repeater and the downlink forwarding signal transmitted by the network device to the third device via the repeater may be included in the same signal.

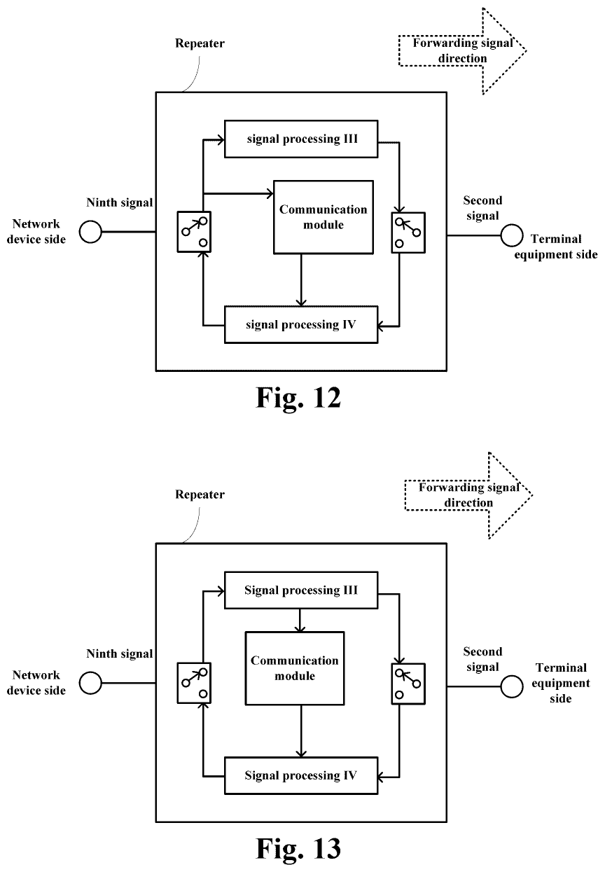

FIG. 12 is an example diagram of a repeater in an embodiment of the present application. As shown in FIG. 12, after receiving the ninth signal (including the first signal and the fifth signal) transmitted by the network device, the repeater may obtain the fifth signal transmitted to itself according to an instruction (such as PDCCH, etc.), and may at least signal processing the first signal used for forwarding (for example, the ninth signal may be processed as a whole) and forward it to the terminal equipment. After receiving the forwarding signal, the terminal equipment may obtain the second signal transmitted to itself according to the instruction (such as PDCCH, etc.).

FIG. 13 is another example diagram of a repeater in an embodiment of the present application. As shown in FIG. 13, after receiving the ninth signal (including the first signal and the fifth signal) transmitted by the network device, the repeater performs signal processing and may obtain the fifth signal transmitted to itself according to the instruction (such as PDCCH, etc.), and may forward at least the first signal for forwarding to the terminal equipment. After receiving the forwarding signal, the terminal equipment may obtain the second signal transmitted to itself according to the instruction (such as PDCCH, etc.).

In some embodiments, the sixth signal transmitted by the repeater to the network device and the fourth signal forwarded by the repeater to the network device are contained in the same signal transmitted to the network device.

For example, time-domain resources of the sixth signal and time-domain resources of the fourth signal are at least partially identical, and frequency-domain resources of the sixth signal and frequency-domain resources of the fourth signal are different and/or code-domain resources of the sixth signal and code-domain resources of the fourth signal are different. Examples as regards that the time-domain resources are at least partially identical may be seen with reference to FIG. 9 or FIG. 10.

For another example, the frequency-domain resources of the sixth signal and the frequency-domain resources of the fourth signal are at least partially identical, and the time-domain resources of the sixth signal and the time-domain resources of the fourth signal are different and/or the code-domain resources of the sixth signal and the code-domain resources of the fourth signal are different. An example as regards that the frequency-domain resources are at least partially identical may be seen with reference to FIG. 11.

In some embodiments, the sixth signal and the fourth signal in a unit of time are orthogonal. After receiving the same signal above, the network device may use the orthogonality between the sixth signal and the fourth signal to obtain the sixth signal and/or the fourth signal from the same signal.

For example, the time-frequency resources of the sixth signal and the time-frequency resources of the fourth signal are in a time unit, and the time unit is one of the following: a symbol, a slot, a sub-frame, a mini-slot, a smallest scheduling unit not based on slot scheduling;
the time-frequency resources of the sixth signal are orthogonal to the time-frequency resources of the fourth signal, and/or code-domain resources of the sixth signal are orthogonal to code-domain resources of the fourth signal, and/or the sixth signal and the fourth signal are orthogonal in a spatial domain.

Thus, the uplink communication signal transmitted by the repeater to the network device and the uplink forwarding signal from the third device and transmitted to the network device via the repeater may be included in the same signal.

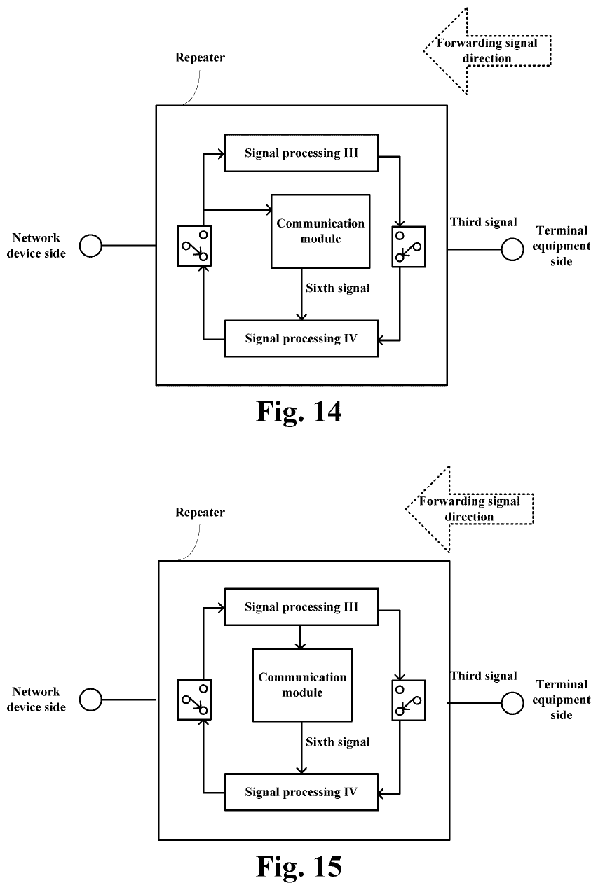

FIG. 14 is an example diagram of a repeater in an embodiment of the present application. As shown in FIG. 14, after receiving the third signal transmitted by the terminal equipment, the repeater may carry out signal processing to generate the fourth signal; the repeater may generate the sixth signal by itself, and may combine the fourth signal and the sixth signal into the same signal and send it to the network device.

FIG. 15 is another example diagram of a repeater in an embodiment of the present application. As shown in FIG. 15, after receiving the third signal transmitted by the terminal equipment, the repeater may carry out signal processing to generate the fourth signal; the repeater may carry out signal processing and generate the sixth signal by itself, and may combine the fourth signal and the sixth signal into the same signal and send it to the network device.

FIG. 12 and FIG. 14 exemplarily show an implementation of signal merging of the repeater, where FIG. 12 shows the downlink and FIG. 14 shows the uplink. FIG. 13 and FIG. 15 exemplarily show another implementation of signal merging of the repeater, where FIG. 13 shows the downlink and FIG. 15 shows the uplink. FIGS. 12 to 15 only schematically illustrate the repeater of the embodiments of the present application, but the present application is not limited to this.

In addition, taking FIGS. 14 and 15 as examples, where the third signal may be an RF signal; the sixth signal may be a baseband signal, an intermediate frequency (IF) signal, or an RF signal. The repeater may combine the third signal and the sixth signal by signal processing at baseband, RF or IF. For example, if the signals are combined in baseband, the sixth signal output from the communication module may be a baseband signal; if the signals are combined in IF, the sixth signal may be a baseband signal or an IF signal; if the signals are combined in RF, the sixth signal may be a baseband signal, an IF signal or an RF signal.

In some embodiments, the seventh signal transmitted by the repeater to the third device and the second signal transmitted by the network device to the third device via the repeater are contained in the same signal from the repeater.

For example, time-domain resources of the seventh signal and time-domain resources of the second signal are at least partially identical, and frequency-domain resources of the seventh signal and frequency-domain resources of the second signal are different and/or code-domain resources of the seventh signal and code-domain resources of the second signal are different. Examples as regards that the time-domain resources are at least partially identical may be seen with reference to FIG. 9 or FIG. 10.

For example, frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different. An example as regards that the frequency-domain resources are at least partially identical may be seen with reference to FIG. 11.

In some embodiments, the time-frequency resources of the seventh signal and the time-frequency resources of the second signal are in a time unit, and the time unit is one of the following: a symbol, a slot, a sub-frame, a mini-slot, a smallest scheduling unit not based on slot scheduling;
the time-frequency resources of the seventh signal are orthogonal to the time-frequency resources of the second signal, and/or code-domain resources of the seventh signal are orthogonal to code-domain resources of the second signal, and/or the seventh signal and the second signal are orthogonal in a spatial domain.

In some embodiments, the eighth signal transmitted by the third device to the repeater and the third signal forwarded to the network device via the repeater are contained in the same signal transmitted to the repeater.

For example, time-domain resources of the eighth signal and time-domain resources of the third signal are at least partially identical, and frequency-domain resources of the eighth signal and frequency-domain resources of the third signal are different and/or code-domain resources of the eighth signal and code-domain resources of the third signal are different. Examples as regards that the time-domain resources are at least partially identical may be seen with reference to FIG. 9 or FIG. 10.

For example, frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different. An example as regards that the frequency-domain resources are at least partially identical may be seen with reference to FIG. 11.

In some embodiments, the time-frequency resources of the eighth signal and the time-frequency resources of the third signal are in a time unit, and the time unit is one of the following: a symbol, a slot, a sub-frame, a mini-slot, a smallest scheduling unit not based on slot scheduling;
the time-frequency resources of the eighth signal are orthogonal to the time-frequency resources of the third signal, and/or code-domain resources of the eighth signal are orthogonal to code-domain resources of the third signal, and/or the eighth signal and the third signal are orthogonal in a spatial domain.

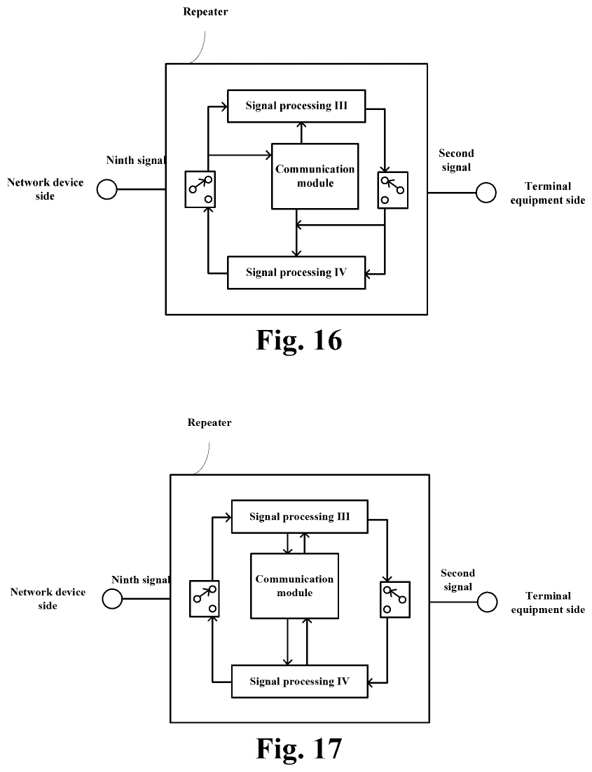

FIG. 16 is an example diagram of a repeater in an embodiment of the present application. As shown in FIG. 16, for example, the repeater receives the ninth signal (including the first signal and the fifth signal) transmitted by the network device, and may obtain the fifth signal transmitted to itself according to an instruction (such as PDCCH, etc.), and may at least signal processing the first signal used for forwarding (for example, the ninth signal may be processed as a whole) and forward it to the terminal equipment. After receiving the forwarding signal, the terminal equipment may obtain the second signal transmitted to itself according to the instruction (such as PDCCH, etc.).

FIG. 16 gives exemplary illustration by taking a situation of downlink transmission as an example, and similar processing may be performed in other situations.

For example, after receiving the third signal transmitted by the terminal equipment, the repeater may carry out signal processing to generate the fourth signal; the repeater may generate the sixth signal by itself, and may combine the fourth signal and the sixth signal into the same signal and send it to the network device.

For another example, after receiving the first signal transmitted by the network device, the repeater may carry out signal processing to generate the second signal; the repeater may generate the seventh signal by itself, and may combine the second signal and the seventh signal into the same signal and send it to the terminal equipment.

For another example, after receiving the tenth signal (including the third signal and the eighth signal) transmitted by the terminal equipment, the repeater performs signal processing and may obtain the eighth signal transmitted to itself according to the instruction, and may forward the third signal used for forwarding to the network device after signal processing.

FIG. 17 is another example diagram of a repeater in an embodiment of the present application. As shown in FIG. 17, for example, after receiving the ninth signal (including the first signal and the fifth signal) transmitted by the network device, the repeater performs signal processing and may obtain the fifth signal transmitted to itself according to an instruction (such as PDCCH, etc.), and may forward at least the first signal for forwarding to the terminal equipment after signal processing. After receiving the forwarding signal, the terminal equipment may obtain the second signal transmitted to itself according to the instruction (such as PDCCH, etc.).

FIG. 17 gives exemplary illustration by taking a situation of downlink transmission as an example, and similar processing may be performed in other situations.

For example, after receiving the third signal transmitted by the terminal equipment, the repeater may carry out signal processing to generate the fourth signal; the repeater may generate the sixth signal by itself, and may combine the fourth signal and the sixth signal into the same signal and send it to the network device.

For another example, after receiving the first signal transmitted by the network device, the repeater may carry out signal processing to generate the second signal; the repeater may generate the seventh signal by itself, and may combine the second signal and the seventh signal into the same signal and send it to the terminal equipment.

For another example, after receiving the tenth signal (including the third signal and the eighth signal) transmitted by the terminal equipment, the repeater performs signal processing and may obtain the eighth signal transmitted to itself according to the instruction, and may forward the third signal used for forwarding to the network device after signal processing.

The schemes of signal combination are schematically illustrated hereinabove, but the present application is not limited to this, and the time division scheme is schematically illustrated hereinafter. In the time division scheme, the communication signal and the forwarding signal may be time division multiplexed (TDM), and the present application is not limited to this.

In some embodiments, the fifth signal transmitted by the network device to the repeater and the first signal transmitted by the network device to the third device via the repeater are located in different time units, the sixth signal transmitted by the repeater to the network device and the fourth signal forwarded by the repeater to the network device are located in different time units.

For example, the network device transmits a downlink communication signal to the repeater and the repeater forwards a downlink forwarding signal between the network device and the terminal equipment are time division, that is, performing at different times. For another example, the repeater transmits an uplink communication signal to the network device and the repeater forwards an uplink forwarding signal between the network device and the terminal equipment are time division, that is, performing at different times.

In some embodiments, the second signal forwarded by the repeater to the third device and the third signal forwarded by the repeater to the network device are located in different time units, the fifth signal transmitted by the network device to the repeater and the sixth signal transmitted by the repeater to the network device are located in different time units.

For example, the repeater forwards a downlink forwarding signal between the network device and the terminal equipment and the repeater forwards an uplink forwarding signal between the network device and the terminal equipment are time division, that is, performing at different times. For another example, the network device transmits a downlink communication signal to the repeater and the repeater transmits an uplink communication signal to the network device are time division, that is, performing at different times.

For another example, the network device transmits a downlink communication signal to the repeater, the repeater forwards a downlink forwarding signal between the network device and the terminal equipment, the repeater transmits an uplink communication signal to the network device, and the repeater forwards an uplink forwarding signal between the network device and the terminal equipment are all time division, that is, performing at different times.

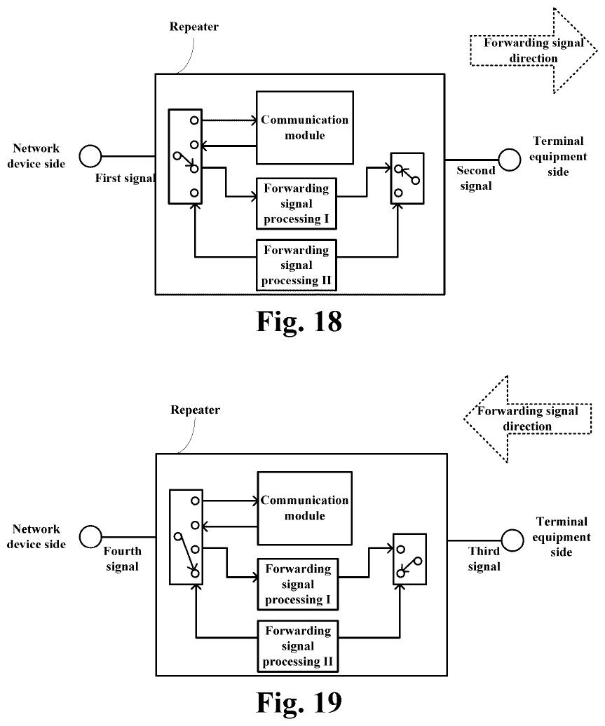

FIG. 18 is an example diagram of a repeater in an embodiment of the present application. As shown in FIG. 18, the repeater forwards the signal from the network device to the terminal equipment. That is, the repeater receives the first signal from the network device, performs signal processing on the first signal to generate the second signal, and transmits the second signal to the terminal equipment. At this time, the repeater forwards the signal without communicating with the network device, and does not demodulate/decode the first signal.

FIG. 19 is another example diagram of a repeater in an embodiment of the present application. As shown in FIG. 19, the repeater forwards the signal from the terminal equipment to the network device. That is, the repeater receives the third signal from the terminal equipment, performs signal processing on the third signal to generate the fourth signal, and transmits the fourth signal to the network device. At this time, the repeater forwards the signal without communicating with the network device, and does not demodulate/decode the third signal.

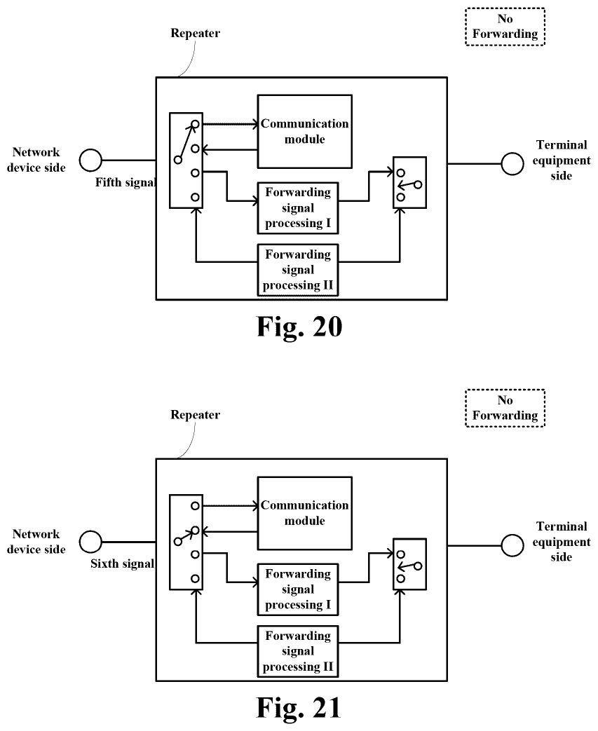

FIG. 20 is an example diagram of a repeater in an embodiment of the present application. As shown in FIG. 20, the repeater does not forward the signal but communicates with the network device. That is, the repeater receives the fifth signal from the network device and demodulates/decodes the fifth signal.

FIG. 21 is an example diagram of a repeater in an embodiment of the present application. As shown in FIG. 21, the repeater does not forward the signal but communicates with the network device. That is, the repeater generates the sixth signal and transmits the sixth signal to the network device.

FIGS. 18 to 21 exemplarily show an implementation of time division of the repeater, respectively showing the time division for the downlink forwarding signal, the uplink forwarding signal, the downlink communication signal and the uplink communication signal. FIGS. 18 to 21 only schematically illustrate the repeater of the embodiments of the present application, but the present application is not limited to this.

For example, on the basis of FIGS. 18 to 21, the communication between the repeater and the terminal equipment may be time division with the forwarding between the repeater and the terminal equipment, or may be time division with the communication or forwarding between the repeater and the network device.

In some embodiments, the seventh signal transmitted by the repeater to the third device and the second signal transmitted by the network device to the third device via the repeater are located in different time units, the eighth signal transmitted by the third device to the repeater and the third signal forwarded by the repeater to the network device are located in different time units.

For example, the second signal forwarded by the repeater to the terminal equipment and the third signal forwarded by the repeater to the network device are located in different time units, and/or, the seventh signal transmitted by the repeater to the terminal equipment and the eighth signal transmitted by the repeater to the network device are located in different time units.

In some embodiments, the fifth signal transmitted by the network device to the repeater and the first signal transmitted by the network device to the third device via the repeater are contained in a ninth signal; the ninth signal, the sixth signal transmitted by the repeater to the network device and the fourth signal forwarded by the repeater to the network device are located in different time units.

For example, the downlink communication signal transmitted by the network device to the repeater and the downlink forwarding signal between the network device and the terminal equipment that is forwarded by the repeater are contained in the same signal; the network device transmits the same signal to the repeater, the repeater transmits an uplink communication signal to the network device, and the repeater forwards an uplink forwarding signal between the network device and the terminal equipment are time division, that is, performing at different times. For another example, the repeater forwards a downlink forwarding signal between the network device and the terminal equipment and the repeater forwards an uplink forwarding signal between the network device and the terminal equipment are time division, that is, performing at different times.

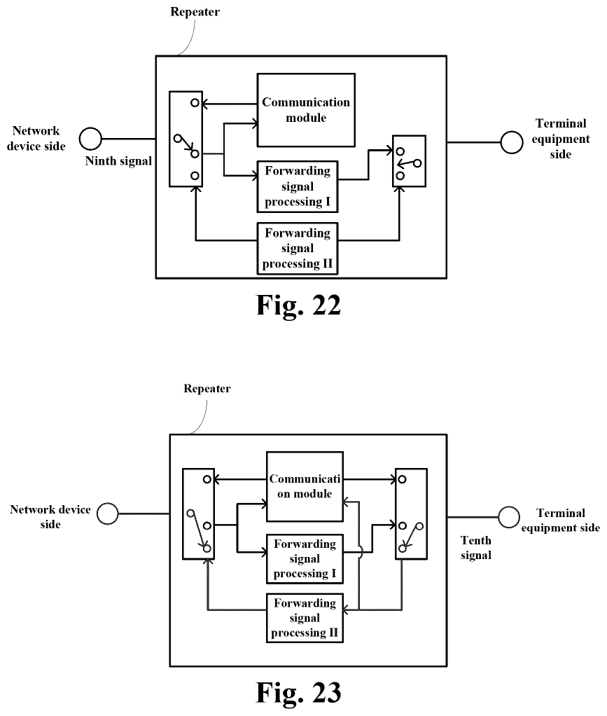

FIG. 22 is an example diagram of a repeater in an embodiment of the present application. As shown in FIG. 22, the repeater receives the ninth signal (including the first signal and the fifth signal) from the network device. The repeater processes the ninth signal to obtain the fifth signal. The repeater may also perform signal processing on at least the first signal in the ninth signal (or may also process the ninth signal as a whole) to generate the second signal and transmit the second signal to the terminal equipment.

FIG. 22 exemplarily shows another implementation of time division of the repeater, showing the case where the downlink forwarding signal and the downlink communication signal are contained in the same signal, and the case of the uplink forwarding signal and the uplink communication signal is omitted herein, similarly referring to FIG. 19 and FIG. 21. FIG. 22 only schematically illustrates the repeater of the embodiments of the present application, but the present application is not limited to this.

In some embodiments, the eighth signal transmitted by the third device to the repeater and the third signal transmitted by the third device to the network device via the repeater are contained in a tenth signal; the tenth signal, the seventh signal transmitted by the repeater to the third device and the second signal forwarded by the repeater to the third device are located in different time units.

FIG. 23 is an example diagram of a repeater in an embodiment of the present application. As shown in FIG. 23, the repeater receives the tenth signal (including the third signal and the eighth signal) from the terminal equipment. The repeater processes the tenth signal to obtain the eighth signal. The repeater may also perform signal processing on at least the third signal in the tenth signal (or may also process the tenth signal as a whole) to generate the fourth signal and transmit the fourth signal to the network device.

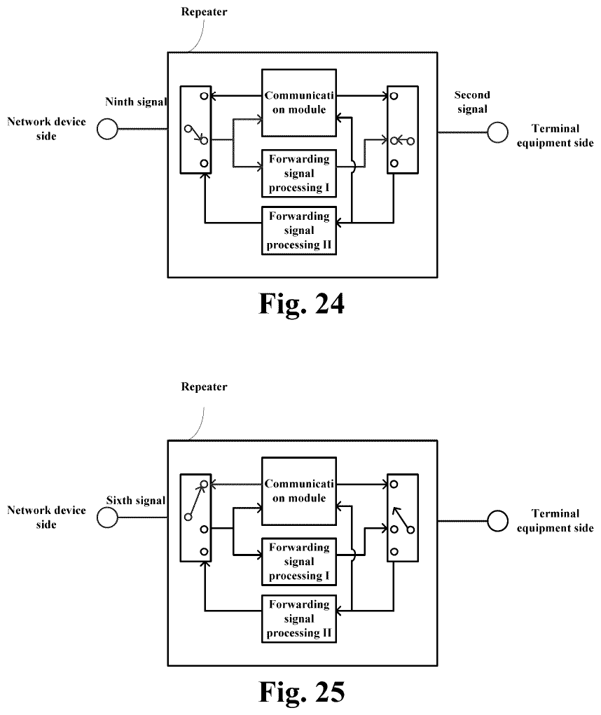

FIG. 24 is another example diagram of a repeater in an embodiment of the present application. As shown in FIG. 24, the repeater receives the ninth signal (including the first signal and the fifth signal) from the network device. The repeater processes the ninth signal to obtain the fifth signal. The repeater may perform signal processing on at least the first signal in the ninth signal to generate the second signal and transmit the second signal to the terminal equipment.

FIG. 25 is another example diagram of a repeater in an embodiment of the present application. As shown in FIG. 25, the repeater does not forward the signal but communicates with the network device. That is, the repeater generates the sixth signal and transmits the sixth signal to the network device.

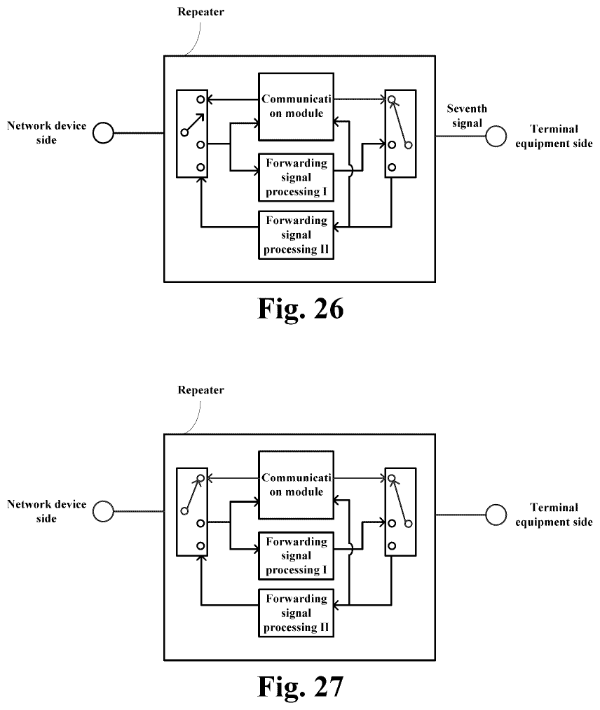

FIG. 26 is another example diagram of a repeater transmitting a downlink signal in an embodiment of the present application. As shown in FIG. 26, the repeater does not forward the signal but communicates with the terminal equipment. That is, the repeater generates the seventh signal and transmits the seventh signal to the terminal equipment.

FIG. 27 is another example diagram of a repeater in an embodiment of the present application. As shown in FIG. 27, the repeater does not forward the signal but communicates with the terminal equipment and the network device. That is, the repeater generates the sixth signal and transmits the sixth signal to the network device; the repeater generates the seventh signal and transmits the seventh signal to the terminal equipment.

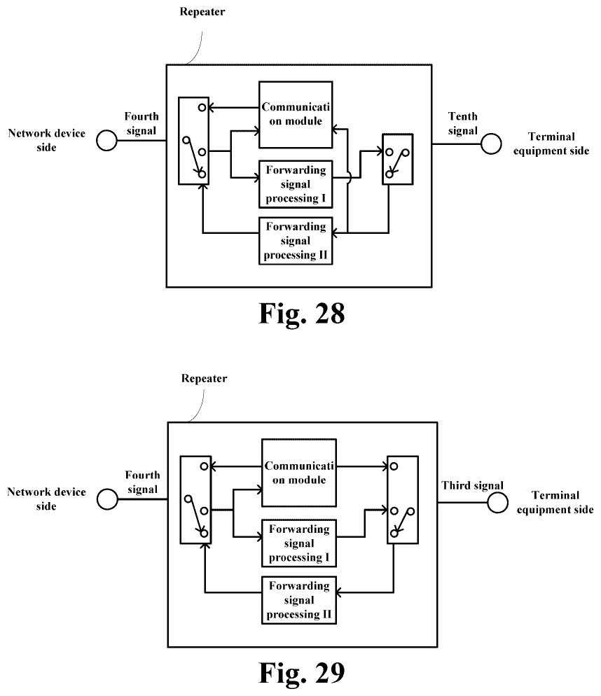

FIG. 28 is another example diagram of a repeater in an embodiment of the present application. As shown in FIG. 28, the repeater receives the tenth signal (including the third signal and the eighth signal) from the terminal equipment. The repeater processes the tenth signal to obtain the eighth signal. The repeater may perform signal processing on at least the third signal in the tenth signal to generate the fourth signal and transmit the fourth signal to the network device.

FIG. 29 is another example diagram of a repeater in an embodiment of the present application. As shown in FIG. 29, the repeater receives the third signal from the terminal equipment. The repeater performs signal processing on the third signal to generate the fourth signal and transmits the fourth signal to the network device.

The time division scheme is schematically illustrated hereinabove, but the present application is not limited to this, and the frequency division scheme (or known as the different frequency scheme) is schematically illustrated hereinafter. Among them, the different frequency scheme for example refers to the use of different frequency resources, such as the use of different frequency bands (frequency ranges) or frequency points, or the use of different carriers or partial bandwidth (BWP).

In some embodiments, the repeater communicates with the network device at a first frequency resource, and at a second frequency resource forwards a signal to be forwarded by the repeater, the first frequency resource not overlapping with the second frequency resource in the frequency domain.

For example, at the first frequency resource, the repeater receives the fifth signal transmitted by the network device and transmits the sixth signal to the network device. That is, the communication between the network device and the repeater is performed using a certain frequency point or band, such as FR1.

For example, at the second frequency resource, the repeater receives the first signal for forwarding and forwards the second signal to the terminal equipment; at the second frequency resource, the repeater receives the third signal for forwarding and forwards the fourth signal to the network device. That is, the forwarding between the network device and the terminal equipment is performed using another frequency point or band, such as FR2.

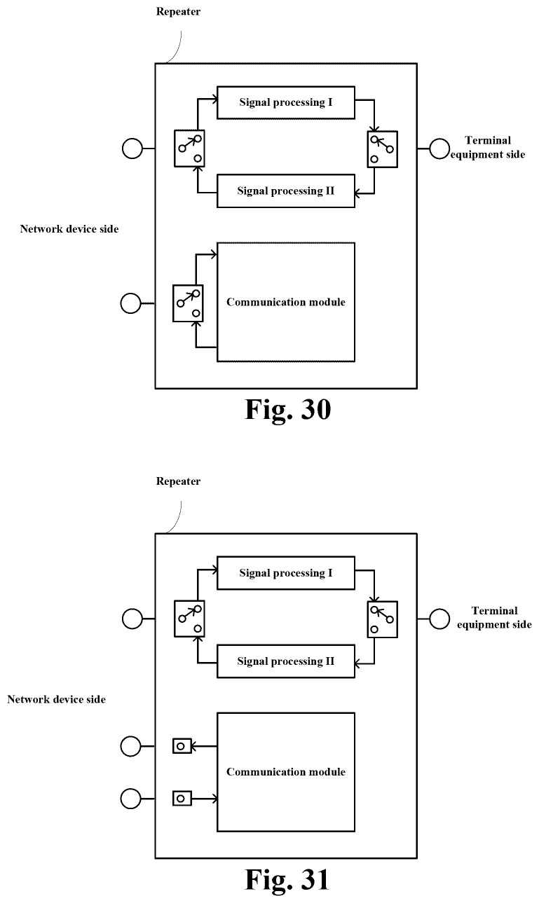

FIG. 30 is another example diagram of a repeater in an embodiment of the present application, exemplarily showing an implementation of different frequency of the repeater. As shown in FIG. 30, the frequency resource used by the communication module of the repeater (communicating with the network device) is different from the frequency resource used by the forwarding module of the repeater (forwarding the signal between the network device and the terminal equipment).

In some embodiments, at a third frequency resource, the repeater receives the fifth signal transmitted by the network device, and transmits the sixth signal to the network device at a fourth frequency resource, the third frequency resource and the fourth frequency resource being located in the first frequency resource;

At the second frequency resource, the repeater receives the first signal for forwarding and forwards the second signal to the third device; at the second frequency resource, the repeater receives the third signal for forwarding and forwards the fourth signal to the network device.

For example, communication between the repeater and the network device may also be frequency-division duplex (FDD).

FIG. 31 is another example diagram of a repeater in an embodiment of the present application, exemplarily showing another implementation of different frequency of the repeater. As shown in FIG. 31, the frequency resource (first frequency resource) used by the communication module of the repeater (communicating with the network device) is different from the frequency resource (second frequency resource) used by the forwarding module of the repeater (forwarding the signal between the network device and the terminal equipment). Moreover, as shown in FIG. 31, the frequency resource (third frequency resource) used in the downlink communication of the communication module of the repeater is different from the frequency resource (fourth frequency resource) used in the uplink communication of the communication module of the repeater.

In some embodiments, at the first frequency resource, the repeater transmits the sixth signal to the network device, and at the second frequency resource, receives the fifth signal transmitted by the network device and forwards the signal to be forwarded via the repeater, the first frequency resource and the second frequency resource not overlapping in the frequency domain.

At the second frequency resource, the repeater receives the first signal for forwarding and forwards the second signal to the third device; at the second frequency resource, the repeater receives the third signal for forwarding and forwards the fourth signal to the network device.

For example, the uplink communication between the network device and the repeater is performed using a certain frequency point or band, such as FR1. The forwarding between the network device and the terminal equipment, and the downlink communication between the network device and the repeater are performed using another frequency point or band, such as FR2.

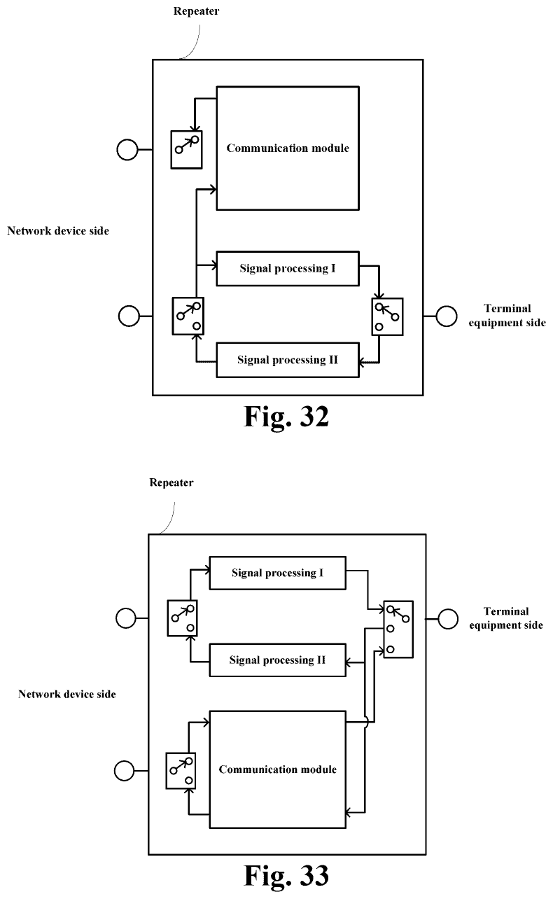

FIG. 32 is another example diagram of a repeater in an embodiment of the present application, exemplarily showing further implementation of different frequency of the repeater. As shown in FIG. 32, the frequency resource used in the uplink transmission of the communication module of the repeater (communicating with the network device) is different from the frequency resource used in the downlink transmission of the forwarding module of the repeater (forwarding the signal between the network device and the terminal equipment) and the communication module.

FIG. 33 is another example diagram of a repeater in an embodiment of the present application, exemplarily showing further implementation of different frequency of the repeater. As shown in FIG. 33, the frequency resource used by the communication module of the repeater (communicating with the network device and/or the terminal equipment) is different from the frequency resource used by the forwarding module of the repeater (forwarding the signal between the network device and the terminal equipment).

In addition, as shown in FIG. 33, the signal transmitted by the terminal equipment to the repeater and the signal transmitted to the network device via the repeater may be combined; the uplink transmission, the downlink communication transmission and downlink forwarding transmission between the repeater and the terminal equipment may be in time division.

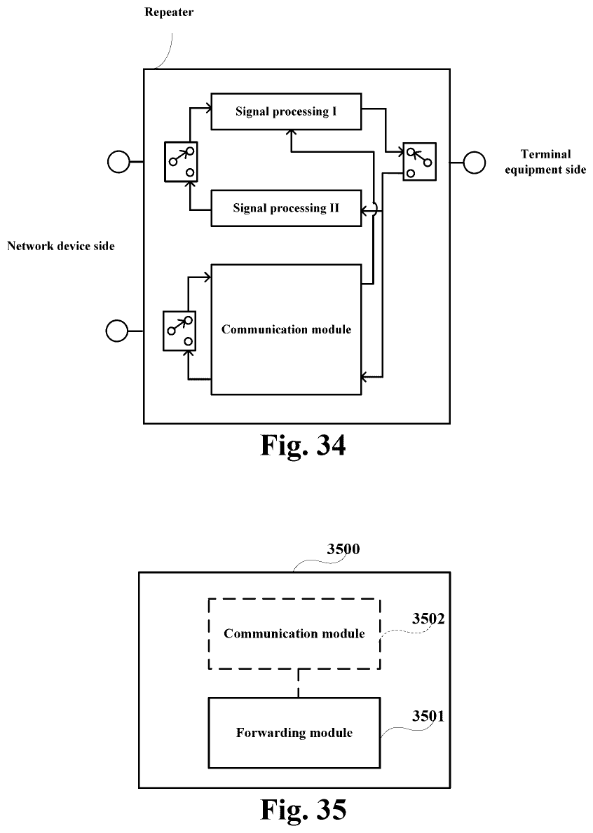

FIG. 34 is another example diagram of a repeater in an embodiment of the present application, exemplarily showing further implementation of different frequency of the repeater. As shown in FIG. 34, the frequency resource used by the communication module of the repeater (communicating with the network device and/or the terminal equipment) is different from the frequency resource used by the forwarding module of the repeater (forwarding the signal between the network device and the terminal equipment).

In addition, as shown in FIG. 34, the signal transmitted by the repeater to the terminal equipment and the signal transmitted to the terminal equipment via the repeater may be combined, and the signal transmitted by the terminal equipment to the repeater and the signal transmitted to the network device via the repeater may be combined; the downlink transmission and uplink communication transmission between the repeater and the terminal equipment may be in time division.

The frequency division scheme is schematically illustrated hereinabove, but the present application is not limited to this.

Only the steps or processes related to the present application are illustrated hereinabove, but the present application is not limited to this. The method of the embodiments of the present application may also include other steps or processes, and the details of these steps or processes may be seen by referring to the related art.

The embodiments above only schematically illustrate the present application, but the present application is not limited to this, and appropriate variations may also be made on the basis of the above embodiments. For example, the above embodiments may be used separately, or one or more of the above embodiments may be combined.

According to the embodiments of the present application, the repeater forwards a signal by a predefined beam or a beam indicated or configured by the network device, thereby achieving better signal coverage and reducing interference to other surrounding devices, thereby improving the transmission efficiency of the entire network.

### Embodiments of Second Aspect

An embodiment of the present application provides a repeater that may, for example, be a network device or a terminal equipment, or some one or more components or assemblies configured on a network device or a terminal equipment.

FIG. 35 is a schematic diagram of a repeater in an embodiment of the present application. Since the principle for the repeater to solve the problem is the same as the method of the embodiments of the first aspect, the specific implementation may be realized referring to the embodiments of the first aspect, and the same contents are not repeated.

As shown in FIG. 35, a repeater 3500 of the embodiments of the present application includes: a forwarding module 3501 for performing forwarding in the RF domain. As shown in FIG. 35, the repeater 3500 may also include a communication module 3502 for communicating with a network device.

In some embodiments, the forwarding module 3501 forwards a signal from a network device by using a predefined beam or a beam indicated or configured by the network device, and/or, forwards a signal to the network device by using a predefined beam or a beam indicated or configured by the network device.

In some embodiments, the forwarding module 3501 is used for receiving a first signal from the network device by using a predefined first beam or a first beam indicated or configured by the network device; performing signal processing on the first signal to generate a second signal; and transmitting the second signal to a third device by using a predefined second beam or a second beam indicated or configured by the network device.

In some embodiments, the forwarding module 3501 is used for receiving a third signal from the third device by using a predefined third beam or a third beam indicated or configured by the network device; performing signal processing on the third signal to generate a fourth signal; and transmitting the fourth signal to the network device by using a predefined fourth beam or a fourth beam indicated or configured by the network device.

In some embodiments, the communication module 3502 receives configuration information used to indicate or configure one or more beams of the repeater transmitted by the network device.

In some embodiments, the communication module 3502 is used for receiving a fifth signal from the network device by using a predefined fifth beam or a fifth beam indicated or configured by the network device; and demodulating and/or decoding the fifth signal.

In some embodiments, the communication module 3502 is used for generating a sixth signal; and transmitting the sixth signal to the network device by using a predefined sixth beam or a sixth beam indicated or configured by the network device.

In some embodiments, the communication module 3502 is used for generating a seventh signal; and transmitting the seventh signal to the third device by using a predefined seventh beam or a seventh beam indicated or configured by the network device.

In some embodiments, the communication module 3502 is used for receiving an eighth signal from the third device by using a predefined eighth beam or an eighth beam indicated or configured by the network device; and demodulating and/or decoding the eighth signal.

In some embodiments, the fifth signal transmitted by the network device to the repeater and the first signal transmitted by the network device to the third device via the repeater are contained in the same signal from the network device.

In some embodiments, time-domain resources of the fifth signal and time-domain resources of the first signal are at least partially identical, and frequency-domain resources of the fifth signal are different from frequency-domain resources of the first signal and/or code-domain resources of the fifth signal are different from code-domain resources of the first signal.

In some embodiments, frequency-domain resources of the fifth signal and frequency-domain resources of the first signal are at least partially identical, and time-domain resources of the fifth signal are different from time-domain resources of the first signal and/or code-domain resources of the fifth signal are different from code-domain resources of the first signal.

In some embodiments, time-frequency resources of the fifth signal and the time-frequency resources of the first signal are in a time unit, the time unit being one of the following: a symbol, a slot, a sub-frame, a mini-slot, a smallest scheduling unit not based on slot scheduling;
the time-frequency resources of the fifth signal are orthogonal to the time-frequency resources of the first signal, and/or, code-domain resources of the fifth signal are orthogonal to code-domain resources of the first signal, and/or, the fifth signal and the first signal are orthogonal in a spatial domain.

In some embodiments, the sixth signal transmitted by the repeater to the network device and the fourth signal forwarded by the repeater to the network device are contained in the same signal transmitted to the network device.

In some embodiments, time-domain resources of the sixth signal and time-domain resources of the fourth signal are at least partially identical, and frequency-domain resources of the sixth signal and frequency-domain resources of the fourth signal are different and/or code-domain resources of the sixth signal and code-domain resources of the fourth signal are different.

In some embodiments, frequency-domain resources of the sixth signal and frequency-domain resources of the fourth signal are at least partially identical, time-domain resources of the sixth signal and time-domain resources of the fourth signal are different and/or code-domain resources of the sixth signal and code-domain resources of the fourth signal are different.

In some embodiments, time-frequency resources of the sixth signal and time-frequency resources of the fourth signal are in a time unit, the time unit being one of the following: a symbol, a slot, a sub-frame, a mini-slot, a smallest scheduling unit not based on slot scheduling; the time-frequency resources of the sixth signal are orthogonal to the time-frequency resources of the fourth signal, and/or code-domain resources of the sixth signal are orthogonal to code-domain resources of the fourth signal, and/or the sixth signal and the fourth signal are orthogonal in a spatial domain.

In some embodiments, a fifth signal transmitted by the network device to the repeater and a first signal transmitted by the network device to a third device via the repeater are located in different time units, a sixth signal transmitted by the repeater to the network device and a fourth signal forwarded by the repeater to the network device are located in different time units.

In some embodiments, a second signal forwarded by the repeater to the third device and a third signal forwarded by the repeater to the network device are located in different time units, the fifth signal transmitted by the network device to the repeater and the sixth signal transmitted by the repeater to the network device are located in different time units.

In some embodiments, a fifth signal transmitted by the network device to the repeater and a first signal transmitted by the network device to the third device via the repeater are contained in a ninth signal;
the ninth signal, a sixth signal transmitted by the repeater to the network device and a fourth signal forwarded by the repeater to the network device are located in different time units.

In some embodiments, the repeater communicates with the network device at a first frequency resource, and at a second frequency resource forwards a signal to be forwarded by the repeater, the first frequency resource not overlapping with the second frequency resource in the frequency domain.

In some embodiments, at the first frequency resource, the repeater receives a fifth signal transmitted by the network device, and transmits a sixth signal to the network device at the first frequency resource; or, at a third frequency resource, the repeater receives a fifth signal transmitted by the network device, and transmits a sixth signal to the network device at a fourth frequency resource, the third frequency resource and the fourth frequency resource being located in the first frequency resource.

In some embodiments, at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.

In some embodiments, at a first frequency resource, the repeater transmits a sixth signal to the network device, and at a second frequency resource, receives a fifth signal transmitted by the network device and forwards the signal to be forwarded via the repeater, the first frequency resource and the second frequency resource not overlapping in the frequency domain.

In some embodiments, at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.

In some embodiments, the seventh signal transmitted by the repeater to the third device and the second signal transmitted by the network device to the third device via the repeater are contained in the same signal from the repeater.

In some embodiments, time-domain resources of the seventh signal and time-domain resources of the second signal are at least partially identical, and frequency-domain resources of the seventh signal and frequency-domain resources of the second signal are different and/or code-domain resources of the seventh signal and code-domain resources of the second signal are different.

In some embodiments, frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different.

In some embodiments, time-frequency resources of the seventh signal and time-frequency resources of the second signal are in a time unit, the time unit being one of the following: a symbol, a slot, a sub-frame, a mini-slot, a smallest scheduling unit not based on slot scheduling;
the time-frequency resources of the seventh signal are orthogonal to the time-frequency resources of the second signal, and/or, code-domain resources of the seventh signal are orthogonal to code-domain resources of the second signal, and/or, the seventh signal and the second signal are orthogonal in a spatial domain.

In some embodiments, the eighth signal transmitted by the third device to the repeater and the third signal forwarded to the network device via the repeater are contained in the same signal transmitted to the repeater.

In some embodiments, time-domain resources of the eighth signal and time-domain resources of the third signal are at least partially identical, and frequency-domain resources of the eighth signal and frequency-domain resources of the third signal are different and/or code-domain resources of the eighth signal and code-domain resources of the third signal are different.

In some embodiments, frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different.

In some embodiments, time-frequency resources of the eighth signal and time-frequency resources of the third signal are in a time unit, the time unit being one of the following: a symbol, a slot, a sub-frame, a mini-slot, a smallest scheduling unit not based on slot scheduling; the time-frequency resources of the eighth signal are orthogonal to the time-frequency resources of the third signal, and/or, code-domain resources of the eighth signal are orthogonal to code-domain resources of the third signal, and/or, the eighth signal and the third signal are orthogonal in a spatial domain.

In some embodiments, the seventh signal transmitted by the repeater to the third device and the second signal transmitted by the network device to the third device via the repeater are located in different time units, the eighth signal transmitted by the third device to the repeater and the third signal forwarded by the repeater to the network device are located in different time units.

In some embodiments, the second signal forwarded by the repeater to the third device and the third signal forwarded by the repeater to the network device are located in different time units;
the seventh signal transmitted by the repeater to the third device and the eighth signal transmitted to the network device via the repeater are located in different time units.

In some embodiments, the eighth signal transmitted by the third device to the repeater and the third signal transmitted by the third device to the network device via the repeater are contained in a tenth signal;
the tenth signal, the seventh signal transmitted by the repeater to the third device and the second signal forwarded to the third device via the repeater are located in different time units.

It is worth noting that only the components or modules related to the present application are illustrated hereinabove, but the present application is not limited to this. The repeater 3500 of the embodiment of the present application may also include other components or modules, and the details of these components or modules may be seen by referring to the related art.

In addition, for the sake of simplicity, FIG. 35 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the present application, but the present application is not limited to this, and appropriate variations may also be made on the basis of the above embodiments. For example, the above embodiments may be used separately, or one or more of the above embodiments may be combined.

According to the embodiments of the present application, the repeater forwards a signal by a predefined beam or a beam indicated or configured by the network device, thereby achieving better signal coverage and reducing interference to other surrounding devices, thereby improving the transmission efficiency of the entire network.

### Embodiments of Third Aspect

An embodiment of the present application provides a communication method of a network device, and is explained from the side of the network device, and the same content as the embodiments of the first aspect is not repeated.

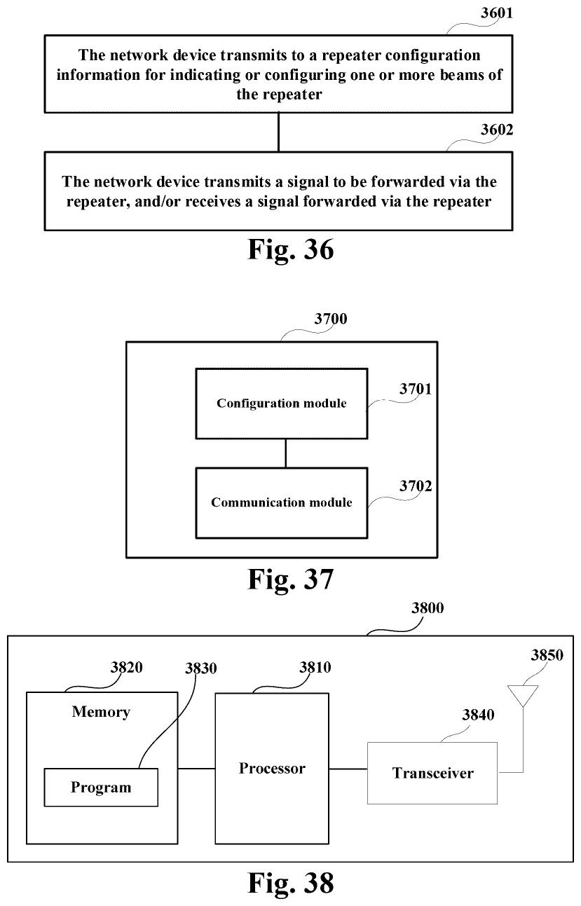

FIG. 36 is a schematic diagram of a communication method of a network device of an embodiment of the present application, as shown in FIG. 36, the method including:
3601, the network device transmits to a repeater configuration information for indicating or configuring one or more beams of the repeater;
3602, the network device transmits a signal to be forwarded via the repeater, and/or receives a signal forwarded via the repeater.

It is worth noting that FIG. 36 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 36 above.

In some embodiments, the network device transmits the signal forwarded to the third device via the repeater, including: the network device transmitting the first signal to the repeater, wherein the repeater receives a first signal from the network device by using a predefined first beam or a first beam indicated or configured by the network device; performs signal processing on the first signal to generate a second signal; and transmits the second signal to a third device by using a predefined second beam or a second beam indicated or configured by the network device.

In some embodiments, the network device receives the signal forwarded from the third device via the repeater, including: the network device receiving the fourth signal transmitted by the repeater, wherein the repeater receives a third signal from the third device by using a predefined third beam or a third beam indicated or configured by the network device; performs signal processing on the third signal to generate a fourth signal; and transmits the fourth signal to the network device by using a predefined fourth beam or a fourth beam indicated or configured by the network device.

In some embodiments, the network device transmits the fifth signal to the repeater, wherein the repeater receives a fifth signal from the network device by using a predefined fifth beam or a fifth beam indicated or configured by the network device; and demodulates and/or decodes the fifth signal.

In some embodiments, the network device receives the sixth signal transmitted by the repeater, wherein the repeater generates the sixth signal, and transmits the sixth signal to the network device by using a predefined sixth beam or a sixth beam indicated or configured by the network device.

In some embodiments, the fifth signal transmitted by the network device to the repeater and the first signal transmitted by the network device to the third device via the repeater are contained in the same signal from the network device.

In some embodiments, time-domain resources of the fifth signal and time-domain resources of the first signal are at least partially identical, and frequency-domain resources of the fifth signal are different from frequency-domain resources of the first signal and/or code-domain resources of the fifth signal are different from code-domain resources of the first signal.

In some embodiments, frequency-domain resources of the fifth signal and frequency-domain resources of the first signal are at least partially identical, and time-domain resources of the fifth signal are different from time-domain resources of the first signal and/or code-domain resources of the fifth signal are different from code-domain resources of the first signal.

In some embodiments, time-frequency resources of the fifth signal and the time-frequency resources of the first signal are in a time unit, the time unit being one of the following: a symbol, a slot, a sub-frame, a mini-slot, a smallest scheduling unit not based on slot scheduling;
the time-frequency resources of the fifth signal are orthogonal to the time-frequency resources of the first signal, and/or, code-domain resources of the fifth signal are orthogonal to code-domain resources of the first signal, and/or, the fifth signal and the first signal are orthogonal in a spatial domain.

In some embodiments, the sixth signal transmitted by the repeater to the network device and the fourth signal forwarded by the repeater to the network device are contained in the same signal transmitted to the network device.

In some embodiments, time-domain resources of the sixth signal and time-domain resources of the fourth signal are at least partially identical, and frequency-domain resources of the sixth signal and frequency-domain resources of the fourth signal are different and/or code-domain resources of the sixth signal and code-domain resources of the fourth signal are different.

In some embodiments, frequency-domain resources of the sixth signal and frequency-domain resources of the fourth signal are at least partially identical, time-domain resources of the sixth signal and time-domain resources of the fourth signal are different and/or code-domain resources of the sixth signal and code-domain resources of the fourth signal are different.

In some embodiments, time-frequency resources of the sixth signal and time-frequency resources of the fourth signal are in a time unit, the time unit being one of the following: a symbol, a slot, a sub-frame, a mini-slot, a smallest scheduling unit not based on slot scheduling; the time-frequency resources of the sixth signal are orthogonal to the time-frequency resources of the fourth signal, and/or code-domain resources of the sixth signal are orthogonal to code-domain resources of the fourth signal, and/or the sixth signal and the fourth signal are orthogonal in a spatial domain.

In some embodiments, a fifth signal transmitted by the network device to the repeater and a first signal transmitted by the network device to a third device via the repeater are located in different time units, a sixth signal transmitted by the repeater to the network device and a fourth signal forwarded by the repeater to the network device are located in different time units.

In some embodiments, the second signal forwarded by the repeater to the third device and the third signal forwarded by the repeater to the network device are located in different time units;
the fifth signal transmitted by the network device to the repeater and the sixth signal transmitted by the repeater to the network device are located in different time units.

In some embodiments, a fifth signal transmitted by the network device to the repeater and a first signal transmitted by the network device to the third device via the repeater are contained in a ninth signal;
wherein the ninth signal, a sixth signal transmitted by the repeater to the network device and a fourth signal forwarded by the repeater to the network device are located in different time units.

In some embodiments, the repeater communicates with the network device at a first frequency resource, and at a second frequency resource forwards a signal to be forwarded by the repeater, the first frequency resource not overlapping with the second frequency resource in the frequency domain.

In some embodiments, at the first frequency resource, the repeater receives the fifth signal transmitted by the network device and transmits the sixth signal to the network device;
at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.

In some embodiments, at a third frequency resource, the repeater receives the fifth signal transmitted by the network device, and transmits the sixth signal to the network device at a fourth frequency resource, the third frequency resource and the fourth frequency resource being located in the first frequency resource;
at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.

In some embodiments, at a first frequency resource, the repeater transmits a sixth signal to the network device, and at a second frequency resource, receives a fifth signal transmitted by the network device and forwards the signal to be forwarded via the repeater, the first frequency resource and the second frequency resource not overlapping in the frequency domain.

In some embodiments, at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.

Only the steps or processes related to the present application are illustrated hereinabove, but the present application is not limited to this. The method of the embodiments of the present application may also include other steps or processes, and the details of these steps or processes may be seen by referring to the related art.

The embodiments above only schematically illustrate the present application, but the present application is not limited to this, and appropriate variations may also be made on the basis of the above embodiments. For example, the above embodiments may be used separately, or one or more of the above embodiments may be combined.

According to the embodiments of the present application, the network device indicates or configures a beam to the repeater, such that the repeater forwards a signal by a predefined beam or a beam indicated or configured by the network device, thereby achieving better signal coverage and reducing interference to other surrounding devices, thereby improving the transmission efficiency of the entire network.

### Embodiments of Fourth Aspect

An embodiment of the present application provides a network device.

FIG. 37 is a schematic diagram of a network device in an embodiment of the present application. Since the principle for the network device to solve the problem is the same as the method of the embodiments of the third aspect, the specific implementation may be realized referring to the embodiments of the first and second aspects, and the same contents are not repeated.

As shown in FIG. 37, a network device 3700 of an embodiment of the present application includes:
a configuration module 3701 which transmits to a repeater configuration information for indicating or configuring one or more beams of the repeater;
a communication module 3702 which transmits a signal to be forwarded via the repeater, and/or receives a signal forwarded via the repeater.

It is worth noting that only the components or modules related to the present application are illustrated hereinabove, but the present application is not limited to this. The network device 3700 of the embodiment of the present application may also include other components or modules, and the details of these components or modules may be seen by referring to the related art.

In addition, for the sake of simplicity, FIG. 37 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the present application, but the present application is not limited to this, and appropriate variations may also be made on the basis of the above embodiments. For example, the above embodiments may be used separately, or one or more of the above embodiments may be combined.

According to the embodiments of the present application, the network device indicates or configures a beam to the repeater, such that the repeater forwards a signal by a predefined beam or a beam indicated or configured by the network device, thereby achieving better signal coverage and reducing interference to other surrounding devices, thereby improving the transmission efficiency of the entire network.

### Embodiments of Fifth Aspect

An embodiment of the present application provides a communication method of a third device, and is explained from the side of the third device, and the same content as the embodiments of the first aspect is not repeated.

In some embodiments, the third device forwards a signal to be forwarded by a repeater to a network device, and/or receives a signal from the network device forwarded by the repeater, by using a predefined beam or a beam indicated or configured by the network device.

In some embodiments, the third device receives the seventh signal generated and transmitted by the repeater, wherein the repeater transmits the seventh signal to the third device by using a predefined seventh beam or a seventh beam indicated or configured by the network device.

In some embodiments, the third device generates and transmits the eighth signal, wherein the repeater receives an eighth signal from the third device by using a predefined eighth beam or an eighth beam indicated or configured by the network device, and demodulates and/or decodes the eighth signal.

In some embodiments, the seventh signal transmitted by the repeater to the third device and the second signal transmitted by the network device to the third device via the repeater are contained in the same signal from the repeater.

In some embodiments, time-domain resources of the seventh signal and time-domain resources of the second signal are at least partially identical, and frequency-domain resources of the seventh signal and frequency-domain resources of the second signal are different and/or code-domain resources of the seventh signal and code-domain resources of the second signal are different.

In some embodiments, frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different.

In some embodiments, time-frequency resources of the seventh signal and time-frequency resources of the second signal are in a time unit, the time unit being one of the following: a symbol, a slot, a sub-frame, a mini-slot, a smallest scheduling unit not based on slot scheduling; the time-frequency resources of the seventh signal are orthogonal to the time-frequency resources of the second signal, and/or, code-domain resources of the seventh signal are orthogonal to code-domain resources of the second signal, and/or, the seventh signal and the second signal are orthogonal in a spatial domain.

In some embodiments, the eighth signal transmitted by the third device to the repeater and the third signal forwarded to the network device via the repeater are contained in the same signal transmitted to the repeater.

In some embodiments, time-domain resources of the eighth signal and time-domain resources of the third signal are at least partially identical, and frequency-domain resources of the eighth signal and frequency-domain resources of the third signal are different and/or code-domain resources of the eighth signal and code-domain resources of the third signal are different.

In some embodiments, frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different.

In some embodiments, time-frequency resources of the eighth signal and time-frequency resources of the third signal are in a time unit, the time unit being one of the following: a symbol, a slot, a sub-frame, a mini-slot, a smallest scheduling unit not based on slot scheduling;
the time-frequency resources of the eighth signal are orthogonal to the time-frequency resources of the third signal, and/or, code-domain resources of the eighth signal are orthogonal to code-domain resources of the third signal, and/or, the eighth signal and the third signal are orthogonal in a spatial domain.

In some embodiments, the seventh signal transmitted by the repeater to the third device and the second signal transmitted by the network device to the third device via the repeater are located in different time units, the eighth signal transmitted by the third device to the repeater and the third signal forwarded by the repeater to the network device are located in different time units.

In some embodiments, the second signal forwarded by the repeater to the third device and the third signal forwarded by the repeater to the network device are located in different time units;
the seventh signal transmitted by the repeater to the third device and the eighth signal transmitted to the network device via the repeater are located in different time units.

In some embodiments, the eighth signal transmitted by the third device to the repeater and the third signal transmitted by the third device to the network device via the repeater are contained in a tenth signal;
the tenth signal, the seventh signal transmitted by the repeater to the third device and the second signal forwarded to the third device via the repeater are located in different time units.

Only the steps or processes related to the present application are illustrated hereinabove, but the present application is not limited to this. The method of the embodiment of the present application may also include other steps or processes, and the details of these steps or processes may be seen by referring to the related art.

The embodiments above only schematically illustrate the present application, but the present application is not limited to this, and appropriate variations may also be made on the basis of the above embodiments. For example, the above embodiments may be used separately, or one or more of the above embodiments may be combined.

According to the embodiments of the present application, the network device indicates or configures a beam to the repeater, such that the repeater forwards a signal by a predefined beam or a beam indicated or configured by the network device, thereby achieving better signal coverage and reducing interference to other surrounding devices, thereby improving the transmission efficiency of the entire network.

### Embodiments of Sixth Aspect

An embodiment of the present application provides a communication system. FIG. 1 is a schematic diagram of a communication system of an embodiment of the present application. As shown in FIG. 1, a communication system 100 includes a network device 101, a repeater 102 and a terminal equipment 103. For the sake of simplicity, FIG. 1 gives exemplary illustration by taking only one network device, one repeater and one terminal equipment as an example, but the embodiments of the present application are not limited to this.

In the embodiments of the present application, existing services or services that may be implemented in the future may be transmitted between the network device 101 and the terminal equipment 103. For example, these services may include, but are not limited to, enhanced mobile broadband (eMBB), large-scale machine-type communications (mMTC), highly reliable low-latency communications (URLLC), and vehicle-to-vehicle (V2X) communications, and etc. The repeater 102 is configured to perform the communication method described in the embodiments of the first aspect, the network device 101 is configured to perform the communication method described in the embodiments of the third aspect, and the terminal equipment 103 is configured to perform the communication method described in the embodiments of the fifth aspect, the contents are incorporated here and will not be described here.

An embodiment of the present application further provides an electronic device. The electronic device may be a repeater, a network device, or a third device (such as a terminal equipment).

FIG. 38 is a schematic diagram of composition of an electronic device in an embodiment of the present application. As shown in FIG. 38, an electronic device 3800 may include a processor 3810 (such as a central processing unit (CPU)) and a memory 3820; the memory 3820 is coupled to the processor 3810. The memory 3820 may store various data and also may store the information processing program 3830, and the program 3830 is executed under the control of the processor 3810.

For example, the processor 3810 may be configured to execute the program to implement the communication method as described in the embodiments of the first aspect. For example, the processor 3810 may be configured to perform the following control of forwarding a signal from a network device by using a predefined beam or a beam indicated or configured by the network device, and/or, forwarding a signal to the network device by using a predefined beam or a beam indicated or configured by the network device.

For another example, the processor 3810 may be configured to execute the program to implement the communication method as described in the embodiments of the third aspect. For example, the processor 3810 may be configured to perform the following control of transmitting to the repeater configuration information for indicating or configuring one or more beams of the repeater; and transmitting a signal to be forwarded via the repeater, and/or receiving a signal forwarded via the repeater.

For another example, the processor 3810 may be configured to execute the program to implement the communication method as described in the embodiments of the fifth aspect. For example, the processor 3810 may be configured to perform the following control of transmitting a signal forwarded by a repeater to a network device, and/or receiving a signal from the network device forwarded by the repeater, by using a predefined beam or a beam indicated or configured by the network device.

In addition, as shown in FIG. 38, the electronic device 3800 may further include: a transceiver 3840 and an antenna 3850, etc., wherein the functions of the above components are similar to the relevant art, and are not repeated here. It is worth noting that the electronic device 3800 is not necessarily required to include all of the components shown in FIG. 38; in addition, the electronic device 3800 may further include components not shown in FIG. 38, with reference to the relevant art.

An embodiment of the present application further provides a computer readable program which, when being executed in the repeater, causes a computer to execute the communication method described in the embodiments of the first aspect in the repeater.

An embodiment of the present application further provides a storage medium storing a computer readable program which causes the computer to execute the communication method described in the embodiments of the first aspect in the repeater.

An embodiment of the present application further provides a computer readable program which, when being executed in the network device, causes the computer to execute the communication method described in the embodiments of the third aspect in the network device.

An embodiment of the present application further provides a storage medium storing a computer readable program which causes the computer to execute the communication method described in the embodiments of the third aspect in the network device.

An embodiment of the present application further provides a computer readable program which, when being executed in the third device, causes the computer to execute the communication method described in the embodiments of the fifth aspect in the third device.

An embodiment of the present application further provides a storage medium storing a computer readable program which causes the computer to execute the communication method described in the embodiments of the fifth aspect in the third device.

The above devices and methods of the present application may be implemented by hardware or by hardware combined with software. The present application relates to a computer readable program which, when being executed by a logic unit, enables the logic unit to implement the devices or components mentioned above, or enables the logic unit to implement the methods or steps described above. The logic unit is, for example, a field programmable logic unit, a microprocessor, a processor used in the computer, etc. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules may correspond to the steps shown in the drawings respectively. These hardware modules may be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium may be coupled to a processor so that the processor may read information from the storage medium and write information to the storage medium; or the storage medium may be a constituent part of the processor. The processor and the storage medium may be located in the ASIC. The software module may be stored in the memory of the mobile terminal or in a memory card that may be inserted into the mobile terminal. For example, if a device (such as a mobile terminal) uses a large-capacity MEGA-SIM card or a large-capacity flash memory device, the software module may be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art may make various variations and modifications to the present application according to spirit and principle of the application, and these variations and modifications should also be within the scope of the present application.

With respect to the above-mentioned embodiments disclosed in the embodiment, the following supplements are further disclosed:
1. A communication method of a repeater, including:
forwarding, by the repeater, a signal from a network device by using a predefined beam or a beam indicated or configured by the network device, and/or, forwarding, by the repeater, a signal to the network device by using a predefined beam or a beam indicated or configured by the network device.
2. The method according to the supplement 1, wherein the forwarding, by the repeater, a signal from a network device by using a predefined beam or a beam indicated or configured by the network device, includes:
receiving, by the repeater, a first signal from the network device by using a predefined first beam or a first beam indicated or configured by the network device;
performing, by the repeater, signal processing on the first signal to generate a second signal; and
transmitting, by the repeater, the second signal to a third device by using a predefined second beam or a second beam indicated or configured by the network device.
3. The method according to the supplement 1, wherein the forwarding, by the repeater, a signal to the network device by using a predefined beam or a beam indicated or configured by the network device, includes:
receiving, by the repeater, a third signal from the third device by using a predefined third beam or a third beam indicated or configured by the network device;
performing, by the repeater, signal processing on the third signal to generate a fourth signal; and
transmitting, by the repeater, the fourth signal to the network device by using a predefined fourth beam or a fourth beam indicated or configured by the network device.
4. The method according to any of the supplements 1 to 3, wherein the method further includes:
receiving, by the repeater, configuration information used to indicate or configure one or more beams of the repeater transmitted by the network device.
5. The method according to any of the supplements 1 to 4, wherein the method further includes:
receiving, by the repeater, a fifth signal from the network device by the repeater by using a predefined fifth beam or a fifth beam indicated or configured by the network device; and
demodulating and/or decoding the fifth signal by the repeater.
6. The method according to any of the supplements 1 to 4, wherein the method further includes:
generating a sixth signal by the repeater; and
transmitting, by the repeater, the sixth signal to the network device by using a predefined sixth beam or a sixth beam indicated or configured by the network device.
7. The method according to any of the supplements 1 to 6, wherein the method further includes:
generating a seventh signal by the repeater; and
transmitting, by the repeater, the seventh signal to a third device by using a predefined seventh beam or a seventh beam indicated or configured by the network device.
8. The method according to any of the supplements 1 to 6, wherein the method further includes:
receiving, by the repeater, an eighth signal from a third device by the repeater by using a predefined eighth beam or an eighth beam indicated or configured by the network device; and
demodulating and/or decoding the eighth signal by the repeater.
9. The method according to any of the supplements 1 to 8, wherein a fifth signal transmitted by the network device to the repeater and a first signal transmitted by the network device to a third device via the repeater are contained in the same signal from the network device.
10. The method according to the supplement 9, wherein time-domain resources of the fifth signal and time-domain resources of the first signal are at least partially identical, and frequency-domain resources of the fifth signal are different from frequency-domain resources of the first signal and/or code-domain resources of the fifth signal are different from code-domain resources of the first signal.
11. The method according to the supplement 9, wherein frequency-domain resources of the fifth signal and frequency-domain resources of the first signal are at least partially identical, and time-domain resources of the fifth signal are different from time-domain resources of the first signal and/or code-domain resources of the fifth signal are different from code-domain resources of the first signal.
12. The method according to the supplement 9, wherein time-frequency resources of the fifth signal and the time-frequency resources of the first signal are in a time unit, the time unit being one of the following: a symbol, a slot, a sub-frame, a mini-slot, a smallest scheduling unit not based on slot scheduling;
the time-frequency resources of the fifth signal are orthogonal to the time-frequency resources of the first signal, and/or, code-domain resources of the fifth signal are orthogonal to code-domain resources of the first signal, and/or, the fifth signal and the first signal are orthogonal in a spatial domain.
13. The method according to any of the supplements 1 to 8, wherein a sixth signal transmitted by the repeater to the network device and a fourth signal forwarded by the repeater to the network device are contained in the same signal transmitted to the network device.
14. The method according to the supplement 13, wherein time-domain resources of the sixth signal and time-domain resources of the fourth signal are at least partially identical, and frequency-domain resources of the sixth signal and frequency-domain resources of the fourth signal are different and/or code-domain resources of the sixth signal and code-domain resources of the fourth signal are different.
15. The method according to the supplement 13, wherein frequency-domain resources of the sixth signal and frequency-domain resources of the fourth signal are at least partially identical, time-domain resources of the sixth signal and time-domain resources of the fourth signal are different and/or code-domain resources of the sixth signal and code-domain resources of the fourth signal are different.
16. The method according to the supplement 13, wherein time-frequency resources of the sixth signal and time-frequency resources of the fourth signal are in a time unit, the time unit being one of the following: a symbol, a slot, a sub-frame, a mini-slot, a smallest scheduling unit not based on slot scheduling;
the time-frequency resources of the sixth signal are orthogonal to the time-frequency resources of the fourth signal, and/or code-domain resources of the sixth signal are orthogonal to code-domain resources of the fourth signal, and/or the sixth signal and the fourth signal are orthogonal in a spatial domain.
17. The method according to any of the supplements 1 to 8, wherein,
a fifth signal transmitted by the network device to the repeater and a first signal transmitted by the network device to a third device via the repeater are located in different time units, a sixth signal transmitted by the repeater to the network device and a fourth signal forwarded by the repeater to the network device are located in different time units.
18. The method according to the supplement 17, wherein the second signal forwarded by the repeater to the third device and the third signal forwarded by the repeater to the network device are located in different time units;
the fifth signal transmitted by the network device to the repeater and the sixth signal transmitted by the repeater to the network device are located in different time units.
19. The method according to any of the supplements 1 to 8, wherein a fifth signal transmitted by the network device to the repeater and a first signal transmitted by the network device to the third device via the repeater are contained in a ninth signal,
wherein the ninth signal, a sixth signal transmitted by the repeater to the network device and a fourth signal forwarded by the repeater to the network device are located in different time units.
20. The method according to any of the supplements 1 to 8, wherein the repeater communicates with the network device at a first frequency resource, and at a second frequency resource forwards a signal to be forwarded by the repeater, the first frequency resource not overlapping with the second frequency resource in the frequency domain.
21. The method according to the supplement 20, wherein, at the first frequency resource, the repeater receives the fifth signal transmitted by the network device and transmits the sixth signal to the network device;
at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.
22. The method according to the supplement 20, wherein, at a third frequency resource, the repeater receives the fifth signal transmitted by the network device, and transmits the sixth signal to the network device at a fourth frequency resource, the third frequency resource and the fourth frequency resource being located in the first frequency resource;
at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.
23. The method according to any of the supplements 1 to 8, wherein at a first frequency resource, the repeater transmits a sixth signal to the network device, and at a second frequency resource, receives a fifth signal transmitted by the network device and forwards the signal to be forwarded via the repeater;
the first frequency resource and the second frequency resource do not overlap in the frequency domain.
24. The method according to the supplement 23, wherein at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.
25. The method according to any of the supplements 1 to 8, wherein the seventh signal transmitted by the repeater to the third device and the second signal transmitted by the network device to the third device via the repeater are contained in the same signal from the repeater.
26. The method according to the supplement 25, wherein frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different.
27. The method according to the supplement 25, wherein frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different.
28. The method according to the supplement 25, wherein time-frequency resources of the seventh signal and time-frequency resources of the second signal are in a time unit, the time unit being one of the following: a symbol, a slot, a sub-frame, a mini-slot, a smallest scheduling unit not based on slot scheduling;
the time-frequency resources of the seventh signal are orthogonal to the time-frequency resources of the second signal, and/or, code-domain resources of the seventh signal are orthogonal to code-domain resources of the second signal, and/or, the seventh signal and the second signal are orthogonal in a spatial domain.
29. The method according to any of the supplements 1 to 8, wherein the eighth signal transmitted by the third device to the repeater and the third signal forwarded to the network device via the repeater are contained in the same signal transmitted to the repeater.
30. The method according to the supplement 29, wherein frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different.
31. The method according to the supplement 29, wherein frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different.
32. The method according to the supplement 29, wherein time-frequency resources of the eighth signal and time-frequency resources of the third signal are in a time unit, the time unit being one of the following: a symbol, a slot, a sub-frame, a mini-slot, a smallest scheduling unit not based on slot scheduling;
the time-frequency resources of the eighth signal are orthogonal to the time-frequency resources of the third signal, and/or, code-domain resources of the eighth signal are orthogonal to code-domain resources of the third signal, and/or, the eighth signal and the third signal are orthogonal in a spatial domain.
33. The method according to any of the supplements 1 to 8, wherein,
the seventh signal transmitted by the repeater to the third device and the second signal transmitted by the network device to the third device via the repeater are located in different time units, the eighth signal transmitted by the third device to the repeater and the third signal forwarded by the repeater to the network device are located in different time units.
34. The method according to the supplement 33, wherein the second signal forwarded by the repeater to the third device and the third signal forwarded by the repeater to the network device are located in different time units;
the seventh signal transmitted by the repeater to the third device and the eighth signal transmitted to the network device via the repeater are located in different time units.
35. The method according to any of the supplements 1 to 8, wherein the eighth signal transmitted by the third device to the repeater and the third signal transmitted by the third device to the network device via the repeater are contained in a tenth signal;

the tenth signal, the seventh signal transmitted by the repeater to the third device and the second signal forwarded to the third device via the repeater are located in different time units.
36. A communication method of a network device, including:
transmitting to a repeater configuration information for indicating or configuring one or more beams of the repeater by the network device; and
transmitting a signal to be forwarded via the repeater, and/or receiving a signal forwarded via the repeater, by the network device.
37. The method according to the supplement 36, wherein the transmitting, by the network device, a signal to be forwarded via the repeater, includes:
transmitting, by the network device, the first signal to the repeater,
wherein the repeater receives a first signal from the network device by using a predefined first beam or a first beam indicated or configured by the network device; performs signal processing on the first signal to generate a second signal; and transmits the second signal to the third device by using a predefined second beam or a second beam indicated or configured by the network device.
38. The method according to the supplement 36, wherein, the receiving, by the network device, a signal forwarded by the repeater, includes:
receiving, by the network device, the fourth signal transmitted by the repeater,
wherein the repeater receives a third signal from the third device by using a predefined third beam or a third beam indicated or configured by the network device; performs signal processing on the third signal to generate a fourth signal; and transmits the fourth signal to the network device by using a predefined fourth beam or a fourth beam indicated or configured by the network device.
39. The method according to any of the supplements 36 to 38, wherein the method further includes:
transmitting, by the network device, the fifth signal to the repeater,
wherein, the repeater receives the fifth signal from the network device by using a predefined fifth beam or a fifth beam indicated or configured by the network device; and demodulates and/or decodes the fifth signal.
40. The method according to any of the supplements 36 to 38, wherein the method further includes:
receiving, by the network device, the sixth signal transmitted by the repeater,
wherein the repeater generates the sixth signal; and transmits the sixth signal to the network device by using a predefined sixth beam or a sixth beam indicated or configured by the network device.
41. The method according to any of the supplements 36 to 40, wherein a fifth signal transmitted by the network device to the repeater and a first signal transmitted by the network device to a third device via the repeater are contained in the same signal from the network device.
42. The method according to the supplement 41, wherein time-domain resources of the fifth signal and time-domain resources of the first signal are at least partially identical, and frequency-domain resources of the fifth signal are different from frequency-domain resources of the first signal and/or code-domain resources of the fifth signal are different from code-domain resources of the first signal.
43. The method according to the supplement 41, wherein frequency-domain resources of the fifth signal and frequency-domain resources of the first signal are at least partially identical, and time-domain resources of the fifth signal are different from time-domain resources of the first signal and/or code-domain resources of the fifth signal are different from code-domain resources of the first signal.
44. The method according to the supplement 41, wherein time-frequency resources of the fifth signal and the time-frequency resources of the first signal are in a time unit, the time unit being one of the following: a symbol, a slot, a sub-frame, a mini-slot, a smallest scheduling unit not based on slot scheduling;
the time-frequency resources of the fifth signal are orthogonal to the time-frequency resources of the first signal, and/or, code-domain resources of the fifth signal are orthogonal to code-domain resources of the first signal, and/or, the fifth signal and the first signal are orthogonal in a spatial domain.
45. The method according to any of the supplements 36 to 40, wherein a sixth signal transmitted by the repeater to the network device and a fourth signal forwarded by the repeater to the network device are contained in the same signal transmitted to the network device.
46. The method according to the supplement 45, wherein time-domain resources of the sixth signal and time-domain resources of the fourth signal are at least partially identical, and frequency-domain resources of the sixth signal and frequency-domain resources of the fourth signal are different and/or code-domain resources of the sixth signal and code-domain resources of the fourth signal are different.
47. The method according to the supplement 45, wherein frequency-domain resources of the sixth signal and frequency-domain resources of the fourth signal are at least partially identical, time-domain resources of the sixth signal and time-domain resources of the fourth signal are different and/or code-domain resources of the sixth signal and code-domain resources of the fourth signal are different.
48. The method according to the supplement 45, wherein time-frequency resources of the sixth signal and time-frequency resources of the fourth signal are in a time unit, the time unit being one of the following: a symbol, a slot, a sub-frame, a mini-slot, a smallest scheduling unit not based on slot scheduling;
the time-frequency resources of the sixth signal are orthogonal to the time-frequency resources of the fourth signal, and/or code-domain resources of the sixth signal are orthogonal to code-domain resources of the fourth signal, and/or the sixth signal and the fourth signal are orthogonal in a spatial domain.
49. The method according to any of the supplements 36 to 40, wherein a fifth signal transmitted by the network device to the repeater and a first signal transmitted by the network device to a third device via the repeater are located in different time units, a sixth signal transmitted by the repeater to the network device and a fourth signal forwarded by the repeater to the network device are located in different time units.
50. The method according to the supplement 49, wherein the second signal forwarded by the repeater to the third device and the third signal forwarded by the repeater to the network device are located in different time units;
the fifth signal transmitted by the network device to the repeater and the sixth signal transmitted by the repeater to the network device are located in different time units.
51. The method according to any of the supplements 36 to 40, wherein a fifth signal transmitted by the network device to the repeater and a first signal transmitted by the network device to the third device via the repeater are contained in a ninth signal;
wherein the ninth signal, a sixth signal transmitted by the repeater to the network device and a fourth signal forwarded by the repeater to the network device are located in different time units.
52. The method according to any of the supplements 36 to 40, wherein the repeater communicates with the network device at a first frequency resource, and at a second frequency resource forwards a signal to be forwarded by the repeater, the first frequency resource not overlapping with the second frequency resource in the frequency domain.
53. The method according to the supplement 52, wherein, at the first frequency resource, the repeater receives the fifth signal transmitted by the network device and transmits the sixth signal to the network device;
at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.
54. The method according to the supplement 52, wherein, at a third frequency resource, the repeater receives the fifth signal transmitted by the network device, and transmits the sixth signal to the network device at a fourth frequency resource, the third frequency resource and the fourth frequency resource being located in the first frequency resource;
at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.
55. The method according to any of the supplements 36 to 40, wherein at a first frequency resource, the repeater transmits a sixth signal to the network device, and at a second frequency resource, receives a fifth signal transmitted by the network device and forwards the signal to be forwarded via the repeater, the first frequency resource and the second frequency resource not overlapping in the frequency domain.
56. The method according to the supplement 55, wherein at the second frequency, the repeater receives a first signal for forwarding, and forwards a second signal to a third device at the second frequency resource; at the second frequency resource, the repeater receives a third signal for forwarding, and forwards a fourth signal to the network device at the second frequency resource.
57. A communication method of a third device, including:
forwarding, by the third device, a signal to be forwarded by a repeater to a network device, and/or receiving a signal from the network device forwarded by the repeater, by using a predefined beam or a beam indicated or configured by the network device.
58. The method according to the supplement 57, wherein the method further includes:
receiving, by the third device, the seventh signal generated and transmitted by the repeater;
wherein the repeater transmits the seventh signal to the third device by using a predefined seventh beam or a seventh beam indicated or configured by the network device.
59. The method according to the supplement 57, wherein the method further includes:
generating and transmitting the eighth signal by the third device,
wherein the repeater receives an eighth signal from the third device by using a predefined eighth beam or an eighth beam indicated or configured by the network device, and demodulates and/or decodes the eighth signal.
60. The method according to any of the supplements 57 to 59, wherein the seventh signal transmitted by the repeater to the third device and the second signal transmitted by the network device to the third device via the repeater are contained in the same signal from the repeater.
61. The method according to the supplement 60, wherein frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different.
62. The method according to the supplement 60, wherein frequency-domain resources of the seventh signal and frequency-domain resources of the second signal are at least partially identical, and time-domain resources of the seventh signal and time-domain resources of the second signal are different and/or code-domain resources of the seventh signal and code-domain resources of the second signal are different.
63. The method according to the supplement 60, wherein time-frequency resources of the seventh signal and time-frequency resources of the second signal are in a time unit, the time unit being one of the following: a symbol, a slot, a sub-frame, a mini-slot, a smallest scheduling unit not based on slot scheduling;
the time-frequency resources of the seventh signal are orthogonal to the time-frequency resources of the second signal, and/or, code-domain resources of the seventh signal are orthogonal to code-domain resources of the second signal, and/or, the seventh signal and the second signal are orthogonal in a spatial domain.
64. The method according to any of the supplements 57 to 59, wherein the eighth signal transmitted by the third device to the repeater and the third signal forwarded to the network device via the repeater are contained in the same signal transmitted to the repeater.
65. The method according to the supplement 64, wherein frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different.
66. The method according to the supplement 64, wherein frequency-domain resources of the eighth signal and frequency-domain resources of the third signal are at least partially identical, and time-domain resources of the eighth signal and time-domain resources of the third signal are different and/or code-domain resources of the eighth signal and code-domain resources of the third signal are different.
67. The method according to the supplement 64, wherein time-frequency resources of the eighth signal and time-frequency resources of the third signal are in a time unit, the time unit being one of the following: a symbol, a slot, a sub-frame, a mini-slot, a smallest scheduling unit not based on slot scheduling;
the time-frequency resources of the eighth signal are orthogonal to the time-frequency resources of the third signal, and/or, code-domain resources of the eighth signal are orthogonal to code-domain resources of the third signal, and/or, the eighth signal and the third signal are orthogonal in a spatial domain.
68. The method according to any of the supplements 57 to 59, wherein,
the seventh signal transmitted by the repeater to the third device and the second signal transmitted by the network device to the third device via the repeater are located in different time units, the eighth signal transmitted by the third device to the repeater and the third signal forwarded by the repeater to the network device are located in different time units.
69. The method according to the supplement 68, wherein the second signal forwarded by the repeater to the third device and the third signal forwarded by the repeater to the network device are located in different time units;
the seventh signal transmitted by the repeater to the third device and the eighth signal transmitted to the network device via the repeater are located in different time units.
70. The method according to any of the supplements 57 to 59, wherein the eighth signal transmitted by the third device to the repeater and the third signal transmitted by the third device to the network device via the repeater are contained in a tenth signal;
the tenth signal, the seventh signal transmitted by the repeater to the third device and the second signal forwarded to the third device via the repeater are located in different time units.
71. A repeater including a memory storing a computer program and a processor configured to execute the computer program to implement the communication method according to any of the supplements 1 to 35.
72. A network device including a memory storing a computer program and a processor configured to execute the computer program to implement the communication method according to any of the supplements 36 to 56.
73. A third device including a memory storing a computer program and a processor configured to execute the computer program to implement the communication method according to any of the supplements 57 to 70.

1. A communication method of a repeater, comprising:
receiving a first forwarding signal from a network device by using a predefined first beam or a first beam indicated by the network device,
performing signal processing on the first forwarding signal to generate a second forwarding signal; and
transmitting the second forwarding signal to a third device by using a second beam indicated by the network device or configured by the network device or configured and indicated by the network device;
receiving a third forwarding signal from the third device by using a third beam indicated by the network device or configured by the network device or configured and indicated by the network device;
performing signal processing on the third forwarding signal to generate a fourth forwarding signal; and
transmitting the fourth forwarding signal to the network device by using a predefined fourth beam or a fourth beam indicated by the network device.

2. The communication method according to claim 1, further comprising:
receiving from the network device first information used to configure and/or indicate the second beam and/or the third beam; and
receiving from the network device second information used to indicate the first beam and/or the fourth beam,
wherein the second beam and the third beam in the first information are denoted by beam indexes, the first beam and the fourth beam in the second information are denoted by TCI.

3. The communication method according to claim 2, wherein the first information is semi-static configuration and is carried by RRC signaling, and/or, the first information is dynamic indication.

4. The communication method according to claim 2, wherein the second information is carried by MAC layer signaling.

5. The communication method according to claim 1, further comprising:
receiving a fifth communicating signal from the network device by using a fifth beam, and
demodulating and/or decoding the fifth communicating signal, wherein the fifth beam is predefined or the fifth beam is indicated or configured by the network device.

6. The communication method according to claim 1, further comprising:
generating a sixth communicating signal; and
transmitting the sixth communicating signal to the network device by using a sixth beam,
wherein the sixth beam is predefined or the sixth beam is indicated or configured by the network device.

7. The communication method according to claim 5, wherein the fifth communicating signal and the first forwarding signal are at least partially overlapped in a time domain; or
the fifth communicating signal and the first forwarding signal are not overlapped in the time domain.

8. The communication method according to claim 6, wherein the sixth communicating signal and the fourth forwarding signal are at least partially overlapped in a time domain;
or,
the sixth communicating signal and the fourth forwarding signal are not overlapped in the time domain.

9. The communication method according to claim 5, further comprising:
generating a sixth communicating signal; and
transmitting the sixth communicating signal to the network device by using a sixth beam,
wherein the sixth beam is predefined or the sixth beam is indicated or configured by the network device, the fifth communicating signal and the sixth communicating signal are not overlapped in a time domain, and the second forwarding signal and the third forwarding signal are not overlapped in the time domain.

10. The communication method according to claim 1, further comprising
generating the second forwarding signal at least by performing amplify process on the first forwarding signal, and/or, generating the fourth forwarding signal at least by performing amplify process on the third forwarding signal.

11. The communication method according to claim 1, wherein the network device is a device of a cell where the repeater is located, and/or, the network device is a device of a serving cell of the repeater.

12. The communication method according to claim 1, wherein the repeater does not demodulate and/or decode the first forwarding signal, the second forwarding signal, the third forwarding signal and the fourth forwarding signal.

13. A repeater comprising:
a receiver configured to receive a first forwarding signal from a network device by using a predefined first beam or a first beam indicated by the network device;
a processor configured to perform signal processing on the first forwarding signal to generate a second forwarding signal; and
a transmitter configured to transmit the second forwarding signal to a communication device by using a second beam indicated by the network device or configured by the network device or configured and indicated by the network device,
wherein the receiver is further configured to receive a third forwarding signal from the communication device by using a third beam indicated by the network device or configured by the network device or configured and indicated by the network device,
the processor is further configured to perform signal processing on the third forwarding signal to generate a fourth forwarding signal, and
the transmitter is further configured to transmit the fourth forwarding signal to the network device by using a predefined fourth beam or a fourth beam indicated by the network device.
